(19) United States
(12) Patent Application Publication
(10) Pub. No.: US 2026/0280968 A1
(43) Pub. Date: Sep. 17, 2026

(54) SYSTEM

(71) Applicant: SoftBank Group Corp., Tokyo (JP)

(72) Inventor: Kenichi KIMURA, Tokyo (JP)

(73) Assignee: SoftBank Group Corp., Tokyo (JP)

(21) Appl. No.: 19/551,616

(22) Filed: Feb. 27, 2026

Related U.S. Application Data
(60) Provisional application No. 63/772,913, filed on Mar. 17, 2025.

(51) Int. Cl. H04L 41/0631; G06N 3/044; G06N 3/0455; G06N 3/0475; G06N 3/08

(52) U.S. Cl. CPC H04L 41/0631; G06N 3/044; G06N 3/0455; G06N 3/0475; G06N 3/08

(57) ABSTRACT

A system includes a processor that is configured to receive, via an input unit, system state data input on a daily basis, store the input system state data in a database unit and learn normal operating patterns based on the stored system state data, receive, via a failure input unit, detailed failure information input at a time of occurrence of a system failure, compare the input failure information, by using a matching unit, with past failure data stored in a failure database and with known failure patterns, and present an optimal response procedure based on a result of the comparison, and analyze daily input data, by using a prediction notification unit, predict potential problems based on the analysis, and notify an operator of the potential problems.

### CROSS-REFERENCE TO RELATED APPLICATION

This application claims the benefit of U.S. Provisional Application No. 63/772,913, filed on Mar. 17, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional system operation and monitoring environments rely heavily on manual analysis of heterogeneous operational data, such as system operating status, resource utilization metrics, and error logs, in order to detect failures and to determine appropriate countermeasures. In many cases, operators input daily system state information and incident details into disparate tools or ad-hoc documents, and then manually compare current conditions with past experiences or known failure patterns. As a result, the speed and quality of incident response are strongly dependent on the individual skill and experience of each operator. Furthermore, conventional systems often lack an integrated mechanism for continuously learning normal operating patterns from accumulated operational data and for using those patterns to support both real-time failure response and predictive failure avoidance. In particular, there is no unified system that: systematically collects and stores daily system state data; learns normal behavior from such data; accepts structured failure information at the time of an incident; automatically matches the failure information with past failure cases and known patterns; presents optimal response procedures; and analyzes daily input data to predict latent problems and notify operators in advance. Consequently, operators face increased workload, inconsistent response quality, and delayed or inadequate handling of failures and potential issues.

### SUMMARY

In order to solve the above-described problems, a system is provided that comprises a processor configured to perform integrated collection, learning, matching, and predictive analysis of system operation data. The processor is configured to receive, via an input unit, system state data input on a daily basis, the system state data including, for example, system operating status, resource usage, and error logs, and to store the input system state data in a database unit. The processor is further configured to learn normal operating patterns based on the stored system state data, such that the normal patterns can be used as a baseline for detecting abnormal conditions. The processor is configured to receive, via a failure input unit, detailed failure information input at a time of occurrence of a system failure, the detailed failure information including at least a failure occurrence time, an affected part of the system, an error message, and content of user reports. The processor is configured to compare the input failure information, by using a matching unit, with past failure data stored in a failure database and with known failure patterns, and to present an optimal response procedure to an operator based on a result of the comparison, thereby supporting rapid and effective incident response. In addition, the processor is configured to analyze daily input data, by using a prediction notification unit, to predict potential problems based on the learned normal operating patterns and detected deviations therefrom, and to notify an operator of the potential problems before a serious failure occurs. By virtue of these means, the system reduces operator burden, standardizes and accelerates failure response, and enhances the reliability and service quality of the managed systems.

The term “system state data” refers to information representing an operational condition of a system at a given time, including, for example, system operating status, resource usage metrics such as CPU and memory utilization, network traffic, and error logs or similar diagnostic information.

The term “input unit” refers to a hardware and/or software component that receives system state data or other operational information from an operator, a terminal, or another system, and provides the received information to the processor for further processing. The term “database unit” refers to a hardware and/or software component, including one or more storage devices and associated management software, that stores system state data, failure information, learned patterns, and related operational records in a structured manner that can be accessed and processed by the processor.

The term “normal operating patterns” refers to patterns or baselines of system behavior derived from accumulated system state data over time, the patterns indicating typical or expected values and relationships among operational metrics during non-failure conditions. The term “failure input unit” refers to a hardware and/or software component that receives detailed information about a system failure, including at least a failure occurrence time, an affected part of the system, an error message, and content of user reports, and supplies such information to the processor.

The term “failure information” refers to data describing the occurrence and characteristics of a system failure, including at least the time of occurrence, the affected component or subsystem, one or more error messages, and any user-reported symptoms.

The term “matching unit” refers to a hardware and/or software component that compares current failure information with past failure data or known failure patterns, calculates similarity or correspondence, and outputs results used to identify similar past cases and generate response procedures.

The term “failure database” refers to a portion of the database unit, or a dedicated database, that stores past failure data, including incident descriptions, associated parameters, and resolution procedures, for use in matching and analysis.

The term “known failure patterns” refers to predefined or previously learned descriptions of characteristic conditions, parameter combinations, or sequences of events that are associated with particular types of failures and can be used as reference templates in matching.

The term “optimal response procedure” refers to one or more recommended operational steps that are determined, based on comparison of current failure information with past failure data and known failure patterns, to be suitable for resolving or mitigating a detected failure.

The term “prediction notification unit” refers to a hardware and/or software component that analyzes accumulated system state data and learned normal operating patterns, detects deviations that may indicate potential problems, and generates notifications or alerts for an operator.

The term “potential problems” refers to conditions or trends in system operation that, although not yet resulting in a manifest failure, indicate an increased probability of future failures, performance degradation, or service quality deterioration.

The term “operator” refers to a human user or administrator responsible for monitoring, managing, or maintaining one or more systems, and for reviewing and acting upon the response procedures and notifications provided by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

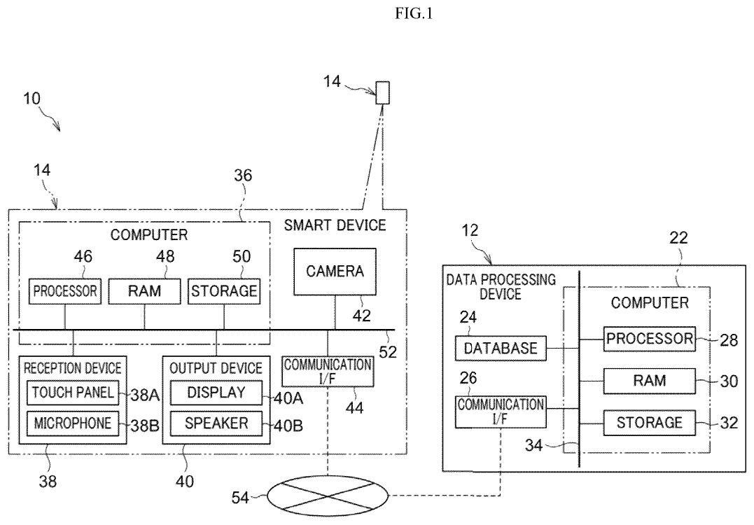

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

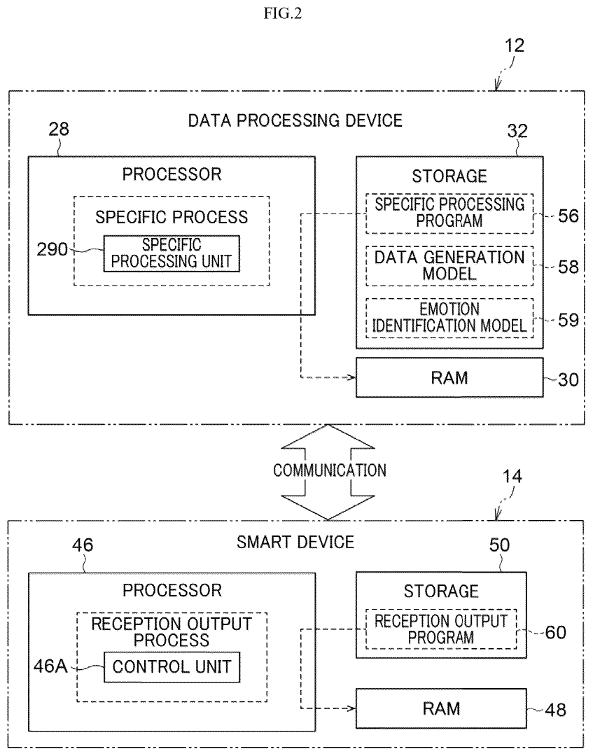

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional system operation support techniques for handling system failures typically rely on static rule sets, manually curated knowledge bases, and simple threshold monitoring of resource metrics. In such conventional techniques, incident response procedures are often predefined as fixed playbooks that do not evolve effectively based on actual execution results. As a consequence, these techniques have difficulty adapting to complex, large-scale, and dynamically changing information processing environments.

In existing systems, anomaly detection is frequently implemented using simple static thresholds on resource utilization, such as computation resource usage, storage resource usage, and communication resource usage, without sufficiently learning time-series baseline patterns or context-dependent variations. This can lead to a high rate of false positives and false negatives, resulting in unnecessary alerts or missed early signs of failures. Furthermore, the correlation between logs, user-reported symptoms, and resource metrics is not fully exploited to derive precise failure patterns and corresponding response procedures.

In addition, when advanced information processing models such as generative AI models become available, conventional systems often use them only in an ad hoc manner, for example by manually crafting textual queries and manually interpreting generated advice. There is no integrated mechanism to systematically construct machine-consumable prompt sentences based on current technical context, incident status, and predictive analytics results, to send such prompt sentences to a generative AI model, to structure the generated natural language advice into operational steps, and to feed back the execution results into subsequent prompt construction and anomaly detection logic. As a result, the generative AI model is not tightly coupled with the system's telemetry, incident database, and predictive models, and its potential to improve the efficiency and accuracy of system operation is not fully realized.

Moreover, conventional incident management systems do not adequately support continuous refinement of similarity calculation for failure matching and anomaly scoring thresholds based on real-world operational feedback. Even when an operator executes recommended procedures, the system usually does not learn from the success or failure of those procedures in a structured way. This lack of feedback-driven learning leads to stagnation of diagnostic quality and limited improvement in the responsiveness and reliability of the overall information processing environment.

Thus, there is a need for an improved computer-implemented technique that: (i) integrates time-series learning of normal operation baselines and anomaly threshold generation; (ii) automatically matches current failures with past failures using text-based similarity metrics; (iii) tightly integrates a generative AI model through systematically constructed prompt sentences based on live system and incident context; and (iv) continuously refines similarity and anomaly detection logic, as well as prompt construction rules, on the basis of operator feedback. Such a technique should improve the functioning of computers themselves as tools for monitoring, diagnosing, and responding to failures, by enabling more accurate, adaptive, and automated incident handling and prediction.

The specific processing by the specific processing unit 290 of the data processing device 12 in Example 1 is realized by the following means.

The present invention provides a server comprising a processor configured to receive, from an information processing terminal operated by a user, input information including operating state information of an information processing environment, including at least computation resource utilization information, storage resource utilization information, communication resource utilization information, and log information; to store the input information as time-series data in a storage unit; to perform aggregation processing and statistical value calculation processing on the time-series data to generate baseline information representing normal operation patterns and threshold information for anomaly determination; to receive, from the information processing terminal at a time of failure, failure information including at least failure occurrence time information, impact range information, display information, user report information, and log information, and to store the failure information as failure event information in the storage unit; to execute, on character information included in the failure event information, text analysis processing including morphological analysis, feature extraction processing, and similarity calculation processing, to compare the failure event information with past failure event information stored in the storage unit, to extract similar failure events based on a similarity value, to retrieve response procedure information associated with the similar failure events, and to synthesize the response procedure information to generate response procedure information for a current failure event; to calculate an anomaly degree on the basis of the baseline information and the threshold information and on new state information received from the information processing terminal, to determine that a potential future failure is present when the anomaly degree exceeds a criterion based on the threshold information, and to generate prediction information and warning information indicating the potential future failure; to generate an input sentence describing a current technical situation, including at least computation resource utilization, communication resource utilization, and failure occurrence status, on the basis of the response procedure information and/or the prediction information and the warning information, to construct a prompt sentence including the input sentence and constraint conditions, to transmit the prompt sentence to a generative information processing model, to receive advice information expressed in natural language from the generative information processing model, and to structure the advice information as step-numbered procedure information to be used as at least a part of the response procedure information and/or the warning information; to transmit the response procedure information and the advice information to the information processing terminal and to control the information processing terminal to display the response procedure information and the advice information as procedures divided into steps; and to collect, from the information processing terminal, execution result information and evaluation information regarding execution of the response procedure information and the advice information, to update parameters used in the similarity calculation processing and in anomaly degree calculation processing, and to update construction rules and templates of the prompt sentence used for the generative information processing model on the basis of the execution result information and the evaluation information. This enables improvement of the functioning of the computer-implemented monitoring and incident response system itself, by adaptively learning normal operation baselines and anomaly thresholds, by automatically generating and refining response procedures and predictive warnings through integrated use of a generative AI model and feedback from actual operational outcomes, thereby increasing accuracy and efficiency of failure detection, diagnosis, and mitigation in complex information processing environments.

The term “information processing terminal” refers to an electronic device including at least a processor, a memory, and a user interface, such as a general-purpose computer, a portable information terminal, or a communication terminal, that is configured to exchange data with a server and to allow a user to input and view information.

The term “information processing environment” refers to a collection of hardware resources, software resources, and communication resources, including at least computation resources, storage resources, and network resources, that cooperate to execute one or more information processing services.

The term “operating state information” refers to data indicating a current or past operational condition of the information processing environment, including at least computation resource utilization information, storage resource utilization information, communication resource utilization information, and log information.

The term “computation resource utilization information” refers to data representing a usage state of processing resources in the information processing environment, such as processor load values, processing time measurements, or task execution counts.

The term “storage resource utilization information” refers to data representing a usage state of storage resources in the information processing environment, such as memory utilization values, storage capacity utilization values, or input/output operation counts.

The term “communication resource utilization information” refers to data representing a usage state of communication resources in the information processing environment, such as network bandwidth usage, packet counts, or communication latency values.

The term “log information” refers to data records generated by hardware components, software components, or communication components, each record including at least a time indication and event-related content such as status messages, error messages, or warning messages.

The term “time-series data” refers to a set of data items, each associated with a time indication, that collectively represent changes of one or more quantities over time.

The term “storage unit” refers to a hardware and software combination, such as a memory device and a data management program, that is configured to store and retrieve data including at least time-series data, failure event information, baseline information, threshold information, and procedure information.

The term “baseline information” refers to information representing normal operation patterns of the information processing environment, obtained by aggregating and statistically analyzing time-series data over a predetermined period.

The term “threshold information” refers to data defining one or more reference values or ranges that are used as criteria for determining whether a value derived from operating state information should be regarded as normal or abnormal.

The term “failure information” refers to information indicating the occurrence and characteristics of a failure in the information processing environment, including at least failure occurrence time information, impact range information, display information, user report information, and log information related to the failure.

The term “failure event information” refers to a structured representation of a failure, obtained by storing and organizing failure information with associated identifiers, timestamps, and related operating state information.

The term “failure occurrence time information” refers to data indicating a time or time range during which a failure occurred or was observed.

The term “impact range information” refers to data indicating elements of the information processing environment affected by a failure, such as affected functions, subsystems, or user groups.

The term “display information” refers to information indicating output content that is presented to a user by the information processing environment, such as screen contents, messages, or error dialogs, at or around the time of a failure.

The term “user report information” refers to information provided by a user or operator describing observed symptoms, usability issues, or other subjective observations relating to a failure.

The term “text analysis processing” refers to processing that analyzes character information contained in one or more text strings and that may include at least tokenization, morphological analysis, syntactic analysis, or similar linguistic processing.

The term “morphological analysis” refers to processing that decomposes a text string into minimal meaningful units, such as words, stems, or morphemes, and that may assign grammatical or lexical attributes to each unit.

The term “feature extraction processing” refers to processing that converts input data, including text or numeric data, into numerical or symbolic feature values suitable for similarity calculation, classification, or other machine learning tasks.

The term “similarity calculation processing” refers to processing that calculates a similarity value between two pieces of information, such as two texts or two sets of features, by using a mathematical measure such as cosine similarity, distance metrics, or correlation.

The term “similar failure events” refers to failure event information records whose similarity value, calculated by the similarity calculation processing relative to a current failure event, satisfies a predetermined criterion.

The term “response procedure information” refers to information describing one or more operations to be executed for diagnosing, mitigating, or resolving a failure, the operations being represented in a form suitable to be followed by a user or an automated process.

The term “current failure event” refers to a failure event information instance corresponding to a failure currently under analysis or handling by the system.

The term “anomaly degree” refers to a value derived from operating state information, baseline information, and threshold information, which quantitatively indicates a degree of deviation from a learned normal operation pattern.

The term “prediction information” refers to information indicating a predicted future condition of the information processing environment, including a likelihood or risk of occurrence of a future failure, derived from the anomaly degree and other analytical results.

The term “warning information” refers to information that notifies a user or another system of a risk or abnormal condition in the information processing environment and that may include recommended timing and priority for response actions.

The term “current technical situation” refers to a set of information describing a present state of the information processing environment, including at least computation resource utilization, communication resource utilization, and failure occurrence status.

The term “input sentence” refers to a text string generated by the system to describe at least a part of the current technical situation, response procedure information, prediction information, or warning information.

The term “prompt sentence” refers to an input text provided to a generative information processing model, the input text including at least one input sentence and optionally including constraint conditions, requests, or contextual descriptions that guide generation by the model.

The term “generative information processing model” refers to a trained information processing model, such as a generative AI model, configured to output information including at least natural language text in response to a prompt sentence.

The term “advice information” refers to information expressed in natural language and generated by the generative information processing model in response to a prompt sentence, the information including at least recommended diagnostic actions, mitigation steps, or operational strategies.

The term “step-numbered procedure information” refers to response procedure information or advice information that has been structured into a sequence of steps, each associated with an order or identifier, so that a user can execute the sequence step by step.

The term “execution result information” refers to information indicating outcomes of execution of response procedure information or advice information, including at least whether each step was executed, whether the failure was mitigated, or what side effects occurred.

The term “evaluation information” refers to information indicating an assessment of the usefulness, correctness, or effectiveness of response procedure information or advice information, the assessment being provided by a user or determined automatically.

The term “construction rules of the prompt sentence” refers to rules, templates, or parameters that define how to generate a prompt sentence from available context information, including selection of included data items, sentence structure, and constraint conditions.

The term “template of the prompt sentence” refers to a reusable text pattern, including placeholders for variable information, that is used as a basis for constructing a specific prompt sentence provided to a generative information processing model.

In an embodiment, a server, a terminal, and a user cooperate to implement the invention.

The server includes at least one processor, a memory, a non-transitory storage device, and a communication interface. The terminal includes at least one processor, a memory, a display, an input device, and a communication interface. The terminal is connected to the server via a communication network such as an IP network.

The terminal executes an application program implemented, for example, as a web browser application using an HTML/JavaScript-based user interface, or as a native application using a graphical user interface framework. The terminal displays operating state information of an information processing environment to the user and accepts user input. The terminal obtains local metrics by calling operating system APIs or system tools such as performance counters, process statistics, or network statistics, and transmits the obtained metrics and user annotations to the server through a secure communication protocol such as HTTPS.

The server executes a server-side application implemented, for example, using a web application framework. The server application includes modules that implement an input management function, a storage function, an analysis function, a failure correlation function, a prediction function, a generative AI integration function, and a feedback learning function. The server stores data in one or more databases implemented using a database management system such as a relational database system or a time-series database system. The server uses a machine learning library and a natural language processing library to execute learning, anomaly detection, similarity computation, and prompt generation.

The terminal periodically acquires computation resource utilization information, storage resource utilization information, and communication resource utilization information from an operating system. For example, the terminal obtains processor usage percentage, memory usage percentage, disk input/output counts, network throughput values, and response times using operating system-specific APIs or utilities. The terminal associates a time indication with each set of metrics and stores them as time-series data in a local buffer. The terminal also monitors log files and system event logs by reading log streams from storage and extracting lines containing error codes or warning codes using pattern matching. The terminal groups related log entries into log events and attaches timestamps and severity levels.

The terminal sends the buffered time-series data and log events to the server at predetermined intervals or upon occurrence of a significant change in metrics. The terminal formats the data as structured objects containing timestamps, metric values, log messages, and user annotations entered through the user interface.

The user observes on the display of the terminal graphical representations and numeric values of the operating state information. The user inputs annotations such as “abnormal CPU usage” or “frequent timeout errors” by selecting check boxes, menu items, or text fields. The terminal associates these annotations with the corresponding time-series segments and log events and transmits them to the server together with the operating state information.

The server receives the time-series data and log events from the terminal through the communication interface. The server parses the received data into internal data structures including metric records, log records, and annotation records. The server stores these records in the storage device as time-series data. The server stores each metric record with fields including at least a timestamp, a computation resource utilization value, a storage resource utilization value, a communication resource utilization value, and a reference to related log records.

The server reads historical time-series data from the storage device to construct baseline information. The server performs aggregation processing, such as computing averages, medians, variances, and quantiles of metric values over predetermined time intervals, for example per five minutes, per hour, or per day. The server also performs periodic pattern analysis by grouping data by time-of-day and day-of-week to identify typical load patterns. The server uses these aggregated statistics to generate baseline information representing normal operation patterns for different time segments and different subsystems of the information processing environment.

The server also generates threshold information by calculating upper and lower bounds for normal ranges. For example, the server may compute a mean u and a standard deviation σ of computation resource utilization for a given time segment and set an upper threshold as μ+kσ, where k is a configurable parameter. In another embodiment, the server applies an anomaly detection algorithm such as an isolation forest model or a one-class support vector machine model to learn a boundary separating normal and abnormal points in a feature space defined by multiple metrics. The server stores model parameters, including trained weights, thresholds, and feature normalization parameters, as threshold information in the storage device.

The server uses a machine learning library to implement the anomaly detection algorithm. In one embodiment, the server constructs a feature vector for each time interval that includes normalized computation resource utilization, normalized storage resource utilization, normalized communication resource utilization, and counts of specific error codes per unit time. The server trains an isolation forest model with a plurality of decision trees built on random subspaces of the feature space. During training, the server minimizes a loss function related to path length distribution for normal samples. The server stores the learned tree structures and feature ranges in the storage device.

When a failure occurs in the information processing environment, the user operates the terminal to input failure information. The terminal displays a failure report screen that includes fields for failure occurrence time, impact range, displayed messages, user-observed symptoms, and attached log excerpts or screenshots. The user inputs the information and confirms transmission to the server.

The server receives the failure information from the terminal and stores it as failure event information in a dedicated failure event table. The server associates the failure event with relevant metric records and log records within a time window around the failure occurrence time. The server links the records using foreign keys or correlation identifiers. The server then executes text analysis processing on character information included in the failure event information, such as error messages and user report texts.

The server uses a natural language processing library to perform tokenization, morphological analysis, and part-of-speech tagging on the error messages and user report texts. The server converts the text into feature vectors using a technique such as term frequency-inverse document frequency or distributed representations such as sentence embeddings derived from a neural network model. In one embodiment, the server uses a neural network model constructed as a multi-layer transformer architecture with an encoder stack comprising multiple self-attention layers and feed-forward layers. The server uses pre-trained weights and may fine-tune the model on a corpus of past failure descriptions.

The server stores, for each past failure event, a text embedding vector and associated response procedure information. When a new failure event is recorded, the server computes an embedding vector for the new failure description and calculates similarity values between the new vector and vectors of past failure events using cosine similarity. The server retrieves those past failure events whose similarity exceeds a predetermined threshold. The server merges response procedure information associated with the retrieved past failure events, removing redundant steps and sorting according to expected effectiveness based on historical success indicators. The server thereby generates response procedure information customized for the current failure event.

The server also performs anomaly detection and prediction by using the baseline information and threshold information. For each newly received metric record, the server constructs a feature vector and applies the trained anomaly detection model. The server computes an anomaly degree that quantifies how much the new feature vector deviates from normal patterns. When the anomaly degree exceeds a criteria derived from the threshold information, the server determines that a potential future failure is present and generates prediction information and warning information indicating the risk, expected time window, and potentially affected subsystems.

In an embodiment, the server improves computational efficiency by using a hierarchical data structure for storing time-series data and pre-computing aggregated statistics. The server maintains summary tables that store per-interval statistics such as mean and standard deviation, and uses these instead of scanning raw metrics for most anomaly checks. This reduces processing time and memory usage and enables faster anomaly detection on high-volume metric streams. The server also reduces network load by allowing the terminal to pre-aggregate metrics over short time windows before transmission, thereby decreasing the number of transmitted records.

The server integrates a generative AI model by constructing a prompt sentence based on the current technical situation. The server generates an input sentence that describes the current metrics, logs, failure status, and previously generated response procedure information and prediction information. The server appends constraint conditions to the input sentence, such as “respond with numbered operational steps,” “limit response to configuration and resource adjustments,” or “do not propose full system shutdown.” The server concatenates these elements into a prompt sentence and transmits it to the generative AI model via an application programming interface.

In one embodiment, the generative AI model is implemented as a neural network having a transformer architecture with multiple encoder-decoder layers, multi-head self-attention, and position-wise feed-forward networks, trained on large-scale text data including technical documentation and operational procedures. The server specifies model parameters such as temperature, maximum output length, and top-k sampling values when invoking the generative AI model. The server receives from the generative AI model advice information expressed in natural language.

The server post-processes the advice information to structure it into step-numbered procedure information. The server detects patterns such as numbered lists, imperative verbs, and headings and organizes the advice into discrete steps. The server associates each step with metadata such as estimated execution time, required privileges, and affected components, which may be inferred from keywords or from the context in the prompt sentence.

The server then transmits the structured response procedure information and the advice information to the terminal. The terminal displays them in a step-by-step format. The user can mark steps as completed, skipped, or not applicable through the input interface of the terminal. The terminal sends execution result information and evaluation information back to the server. The evaluation information may include ratings such as “effective,” “partially effective,” or “ineffective,” and textual comments from the user.

The server uses the execution result information and evaluation information to update internal parameters. For the similarity calculation processing, the server adjusts the importance weights of different textual features based on whether matched past failures led to effective resolutions. For example, the server may increase the weight of certain error codes or symptom expressions that correlate strongly with successful matches. For anomaly detection, the server recalibrates thresholds by analyzing distributions of anomaly degrees that correspond to true positive, false positive, and false negative cases, thereby reducing both unnecessary alerts and missed failures.

The server also updates construction rules and templates of prompt sentences. The server records which types of prompt formulations lead to advice information that is rated as effective. For example, the server may learn that including precise metric values and time ranges in the prompt results in more actionable advice, while leaving out redundant context reduces confusion. The server modifies prompt templates to include those aspects that empirically improve the quality of generated procedures. This feedback-based adjustment is not a simple automation of human work but an optimization of the way the computing system encodes and queries technical context, leading to a systematic improvement in the interaction between the monitoring platform and the generative AI model.

Because the server uses learned baseline information, an anomaly detection model, similarity-based failure matching, and adaptive prompt generation, the system can detect anomalies and generate suitable procedures faster and with higher precision than systems relying on static rules. The cooperation between the terminal and the server, including local pre-aggregation and incremental transmission of metrics, reduces communication load and latency. The hierarchical storage of aggregated metrics reduces the computation time for anomaly detection. These factors contribute to an improvement in the functioning of the computer system itself, including increased processing speed, reduced resource consumption, and improved accuracy of failure detection and response.

In an alternative embodiment, the server uses a recurrent neural network or a convolutional neural network for time-series modeling instead of or in addition to an isolation forest. For example, the server may use a long short-term memory network to model sequences of metric values and predict future values. The server trains such a network by minimizing a loss function, such as mean squared error between predicted and actual values, using gradient descent and backpropagation. The server uses predicted values and confidence intervals to generate prediction information when expected resource utilization exceeds safe thresholds. The use of such sequence models allows the server to capture temporal dependencies and non-linear trends that static thresholds cannot capture, thereby improving prediction accuracy.

In another embodiment, the server employs different feature extraction strategies for different types of failures. For communication-related failures, the server may emphasize features derived from communication resource utilization information such as packet loss rate, jitter, or connection error codes. For computation-related failures, the server may emphasize processor usage spikes and thread-level statistics. The server can select among multiple anomaly detection models and similarity models based on the subsystem or application indicated in the failure information. This modular design enables tailored analysis and further improves detection precision.

In yet another embodiment, the terminal runs on an embedded device or a specialized monitoring appliance deployed in a data center. The terminal gathers metrics from multiple machines via local monitoring protocols and transmits them to the server. The server aggregates metrics from a plurality of terminals and derives multi-node baselines and cross-node correlation structures. In this case, the server can detect anomalies such as cluster-wide degradations and network partitioning patterns that single-node monitoring cannot detect. The described neural network models, similarity algorithms, and prompt construction rules operate in accordance with explicit criteria and data structures. The server does not simply mimic human reasoning but applies mathematical models and update rules that are optimized for the computer's architecture, memory hierarchy, and processing pipelines. As a result, the system reduces computational overhead compared to naive implementations, increases resolution accuracy for complex patterns spread across logs and metrics, and provides structured outputs that are directly usable for machine-driven or human-assisted control of the information processing environment. Through these mechanisms, the invention improves computer technology itself by enhancing how computers collect, store, analyze, and use operational data to manage and control complex systems.

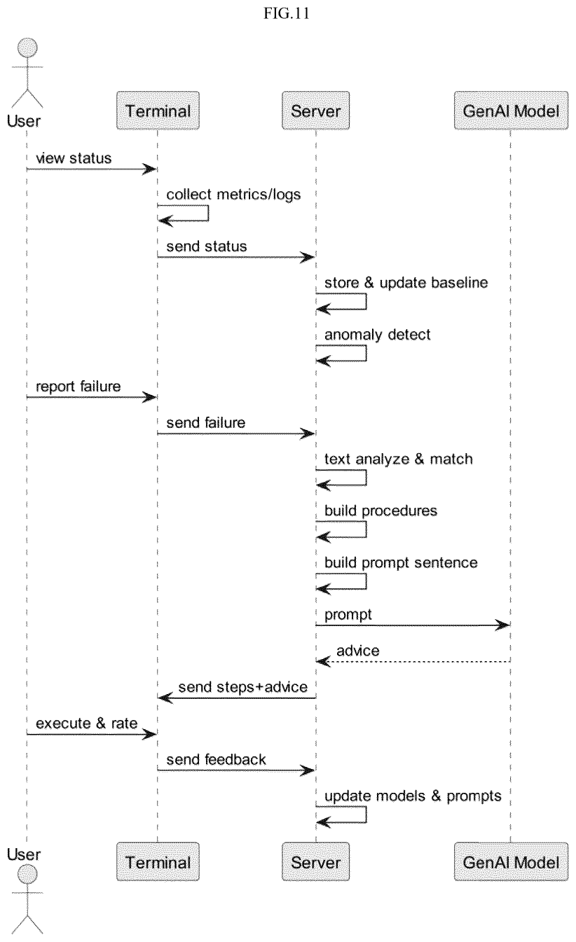

The following describes the processing flow using FIG. 11.

### Step 1:

The terminal acquires local operating state information from an operating system and local applications.

The terminal receives, as input, low-level metric values such as processor usage, memory usage, storage input/output counts, and network throughput obtained via system calls or monitoring utilities.

The terminal calls operating system APIs or executes monitoring commands, parses numeric fields from returned structures or text output, converts the values into normalized numeric formats, and associates them with a current timestamp.

The terminal outputs a structured metric record, for example a key-value object containing timestamped computation resource utilization information, storage resource utilization information, and communication resource utilization information.

### Step 2:

The terminal collects log information and transforms raw log lines into structured log events.

The terminal receives, as input, newly appended log lines from application log files and system event logs detected by file watchers or logging APIs.

The terminal applies pattern matching and regular expressions to each log line, extracts fields such as error code, severity, message text, and origin component, groups related lines by timestamp and correlation identifiers, and discards lines that do not satisfy error or warning criteria.

The terminal outputs log event objects, each including at least a timestamp, severity level, error or warning code, and message content to be associated with corresponding metric records.

### Step 3:

The terminal accepts user annotations regarding abnormal conditions and associates them with metric and log data.

The terminal receives, as input, user operations on a graphical user interface, including selections of time ranges, check boxes indicating abnormality types, and free-form text comments describing observed issues.

The terminal maps the selected time range to stored metric records and log events, attaches flags such as “abnormal CPU usage” or “frequent timeout,” and stores the user comment text alongside identifiers of the affected metric and log records.

The terminal outputs annotation records linking user evaluations to specific time-series segments and log events.

### Step 4:

The terminal transmits operating state information, log events, and user annotations to the server.

The terminal receives, as input, internally stored metric records, log events, and annotation records accumulated over a configurable time window.

The terminal serializes these records into a structured message, assigns a transmission identifier, encrypts the message using a secure transport protocol, and submits it to a network stack for delivery to the server.

The terminal outputs a network request containing the operating state information, log information, and annotation information, and receives from the server a response indicating successful reception or error status.

### Step 5:

The server receives, validates, and stores operating state information, log events, and user annotations.

The server receives, as input, network messages containing metric records, log event objects, and annotation records from one or more terminals.

The server verifies message integrity, parses the structured payload, checks data types and ranges of each field, rejects malformed entries, and normalizes timestamps into a unified reference time.

The server writes validated metric records, log events, and annotations into corresponding tables in a storage unit and outputs stored database records with internal identifiers for subsequent analysis.

### Step 6:

The server generates baseline information and threshold information from historical time-series data.

The server receives, as input, stored metric records spanning a predefined historical period and grouped by measurement type and time interval.

The server performs aggregation operations such as computing averages, medians, standard deviations, and percentiles for each metric within defined time buckets, and applies grouping by time-of-day and day-of-week to learn periodic behavior.

The server outputs baseline information records representing normal operation patterns and threshold information records containing numeric boundaries or learned model parameters used for anomaly evaluation.

### Step 7:

The server trains or updates an anomaly detection model using feature vectors derived from metrics and logs.

The server receives, as input, historical metric values and error occurrence counts, combined into multivariate feature vectors representing normal operating states.

The server applies a machine learning algorithm, for example an isolation forest or one-class support vector machine, constructs model structures such as decision trees or support vectors, and adjusts model parameters to minimize a predefined loss function that penalizes misclassification of normal points.

The server outputs an anomaly detection model instance that encodes learned decision boundaries and stores associated parameters as part of the threshold information.

### Step 8:

The user reports a failure through the terminal, and the terminal structures the failure information.

The terminal receives, as input, user-provided failure details including failure occurrence time, affected component, visible error messages, user-observed symptoms, and optional attachments such as screenshots or log snippets.

The terminal converts date and time text into normalized timestamps, encodes categorical choices as standard labels, compresses or references attachment data, and bundles all items into a structured failure description document.

The terminal outputs a failure information object to be transmitted to the server for registration as failure event information.

### Step 9:

The server registers failure event information and links it to related metrics and logs.

The server receives, as input, the failure information object from the terminal.

The server stores the failure information in a dedicated failure event table, searches time-series metrics and log records within a temporal window surrounding the failure occurrence time, and establishes references between the failure event and associated metric and log records using identifiers.

The server outputs a failure event record that aggregates descriptive fields, related metrics, and related logs for use in subsequent text analysis and similarity computation.

### Step 10:

The server executes text analysis processing on failure descriptions and user reports. The server receives, as input, text fields from the failure event record, including error messages and user report information, as well as text fields from past failure event records.

The server tokenizes the text into words or morphemes, assigns part-of-speech labels, removes non-informative tokens, and converts the remaining text into numerical feature representations such as term frequency-inverse document frequency vectors or dense embedding vectors generated by a neural language model.

The server outputs numerical feature vectors corresponding to the current failure event and to each past failure event, ready for similarity calculation processing.

### Step 11:

The server calculates similarity between the current failure event and past failure events, and selects similar failure events.

The server receives, as input, the feature vector for the current failure event and a set of feature vectors for past failure events.

The server computes similarity values, for example cosine similarity, between the current vector and each past vector, sorts the past events in descending order of similarity, and applies a threshold or top-k selection rule to identify those events considered similar. The server outputs a list of similar failure event identifiers and associated similarity scores.

### Step 12:

The server synthesizes response procedure information based on similar failure events. The server receives, as input, identifiers of similar failure events and their associated response procedure information records, including step sequences and historical success indicators.

The server merges step sequences by removing duplicates, resolving conflicts by prioritizing steps with higher historical success rates or shorter resolution times, and ordering remaining steps according to dependency relationships or recommended execution order.

The server outputs synthesized response procedure information for the current failure event as an ordered list of step descriptions.

### Step 13:

The server evaluates new operating state information in real time and calculates anomaly degrees.

The server receives, as input, new metric records and, optionally, recent error occurrence counts from the storage unit or a streaming buffer.

The server constructs feature vectors using the same feature extraction rules applied at training time, passes the vectors through the previously trained anomaly detection model, and computes anomaly degrees that reflect distances or path lengths relative to normal patterns.

The server outputs anomaly degree values and flags indicating whether each new record is classified as normal or anomalous according to the threshold information.

### Step 14:

The server generates prediction information and warning information when anomaly degrees exceed criteria.

The server receives, as input, anomaly degree values and corresponding metric context such as time, component, and severity.

The server compares anomaly degrees with threshold values, identifies patterns of persistent or escalating anomalies, and estimates the risk and possible timing of future failures by analyzing trends in the anomaly degree sequences.

The server outputs prediction information describing expected failure scenarios and warning information instructing that attention or preemptive action is required.

### Step 15:

The server constructs an input sentence and a prompt sentence for a generative AI model based on current context.

The server receives, as input, synthesized response procedure information, prediction information, warning information, and current operating state information including key metric values and recent error codes.

The server generates an input sentence that summarizes the current technical situation, for example “The system CPU usage is 20% higher than normal for this time of day, and error code E_TIMEOUT has occurred 15 times in the last hour on the database service.” The server appends constraint instructions such as “Respond with numbered operational steps only and avoid recommending full system shutdown unless strictly necessary,” and concatenates these elements into a prompt sentence.

The server outputs a textual prompt sentence to be transmitted to the generative AI model, where the prompt sentence includes both technical facts and explicit output requirements.

### Step 16:

The server transmits the prompt sentence to the generative AI model and receives advice information.

The server receives, as input, the constructed prompt sentence and configuration parameters such as maximum response length, randomness control, and decoding method.

The server sends an inference request including the prompt sentence and parameters to the generative AI model via a model interface, waits for the model to perform neural network inference using its internal transformer architecture, and receives from the model generated text containing recommended diagnostic and mitigation steps.

The server outputs advice information expressed in natural language, as returned by the generative AI model, for subsequent structuring and evaluation.

### Step 17:

The server structures the advice information into step-numbered procedure information. The server receives, as input, the advice information text generated by the generative AI model.

The server analyzes the text to detect delimiters such as numbered lists, bullet points, or imperative sentences, segments the text into discrete steps, and assigns step numbers and metadata such as target components or preconditions to each segment based on keyword analysis and prompt context.

The server outputs step-numbered procedure information that can be directly displayed as an ordered set of executable steps for the user.

### Step 18:

The terminal displays response procedure information and advice information to the user.

The terminal receives, as input, synthesized response procedure information and step-numbered procedure information from the server.

The terminal renders the steps in a graphical interface, showing step numbers, descriptions, the components to be operated on, and recommended execution order, and provides interactive controls for the user to mark each step as “pending,” “in progress,” “completed,” or “skipped.”

The terminal outputs updated display states and records user interactions as local status information for each step.

### Step 19:

The user executes recommended steps and provides execution result information and evaluation information.

The user receives, as input, the displayed steps and their descriptions on the terminal.

The user performs actual operations on the information processing environment, such as changing configuration parameters, restarting services, or reallocating resources, and then uses the terminal interface to record whether each step was executed and how effective it was, including free-form comments indicating observed effects.

The user outputs, through the terminal, execution result information describing step execution outcomes and evaluation information indicating perceived effectiveness.

### Step 20:

The terminal transmits execution result information and evaluation information to the server.

The terminal receives, as input, step status changes and evaluation ratings entered by the user.

The terminal aggregates the statuses, ratings, and comments into structured feedback objects, associates them with identifiers of the corresponding failure event, response procedure, and prompt sentence used, and transmits the feedback objects to the server via the communication interface.

The terminal outputs a feedback message containing execution result information and evaluation information for server-side learning.

### Step 21:

The server updates similarity calculation parameters and anomaly detection parameters based on feedback.

The server receives, as input, feedback messages including execution result information and evaluation information.

The server correlates each feedback instance with the underlying similarity scores and model outputs used when generating the corresponding procedures, computes statistics such as success rates as a function of similarity thresholds and feature weights, and adjusts parameters to increase the contribution of features associated with successful resolutions and decrease the contribution of features associated with failures or false positives.

The server outputs updated model parameters and similarity weighting configurations that refine future failure matching and anomaly scoring.

### Step 22:

The server updates construction rules and templates of prompt sentences based on feedback quality.

The server receives, as input, feedback that associates each prompt sentence and generated advice with evaluation scores reflecting user satisfaction and effectiveness.

The server analyzes which structural elements of prompt sentences, such as inclusion of explicit resource values, time windows, component names, or constraint instructions, correlate with high evaluation scores, and modifies prompt templates by adding, removing, or reordering such elements to optimize the generative AI model's output for the system's operational context.

The server outputs revised prompt construction rules and templates that will guide generation of future prompt sentences, thereby closing the feedback loop between actual operational outcomes and the configuration of the generative AI model interface.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional system operation support technologies for data center environments primarily rely on static rule sets, manually crafted runbooks, and threshold-based alerts computed from monitoring data. Although such approaches can detect simple resource limit violations, they often fail to capture complex multi-metric abnormal patterns, such as combinations of load, temperature, power consumption, and communication volume that evolve over time. As a result, conventional systems generate either excessive false positives or miss early signs of failures, thereby increasing operator workload and prolonging system downtime.

Furthermore, in many existing systems, monitoring components, anomaly detection components, and response recommendation components are implemented as independent subsystems without an integrated feedback loop. Even when historical failure data is stored, it is not effectively utilized to refine anomaly detection criteria or to systematically improve response procedures over time. This limits the system's ability to adapt to changes in workload patterns, infrastructure configurations, and operational policies, and prevents continuous improvement of the reliability and efficiency of the underlying computer systems.

In addition, recent generative AI models are capable of producing context-aware explanations and remediation plans in natural language based on prompt sentences. However, in conventional operation support tools, generative AI models are typically invoked in an ad-hoc manner by human operators who manually compose queries. This manual prompting introduces variability in the quality and completeness of the input, creates additional cognitive burden for operators during time-critical incidents, and makes it difficult to systematically integrate the AI's recommendations into automated control flows. There is no standardized mechanism to automatically construct high-quality prompt sentences from real-time telemetry, learned normal operation patterns, and historical failure knowledge, nor to automatically filter and operationalize the AI's responses under safety and policy constraints.

Moreover, existing systems generally treat monitoring data and AI-generated recommendations as separate artifacts and do not incorporate execution results back into the models in a structured way. Without such a closed loop, the system cannot effectively learn from each incident, and cannot improve future predictions and response planning at the level of the underlying computer technology. Consequently, there is a need for a computer-implemented system that (i) automatically acquires and structures rich time-series operational data, (ii) learns and updates normal behavior patterns and anomaly indices, (iii) programmatically generates prompt sentences for a generative AI model based on current and historical states, (iv) integrates AI-generated response plans with rule-based and historical procedures under explicit operational constraints, and (v) feeds back execution outcomes to adapt future anomaly detection and response generation. Such a system should reduce operator burden, improve the accuracy and timeliness of failure prediction and remediation, and thereby improve the functioning of the computer infrastructure itself in terms of availability, resilience, and resource efficiency.

The specific processing by the specific processing unit 290 of the data processing device 12 in Application Example 1 is realized by the following means.

The present invention provides a server comprising a processor configured to acquire, from an information processing apparatus group and a communication apparatus group, operating state information, resource utilization information, temperature information, electric power consumption information, and communication volume information, and record the acquired information as time-series data; store the time-series data, learn a normal operation pattern based on the time-series data, and calculate an abnormality index; acquire failure state information at a time of failure occurrence or anomaly detection and the abnormality index, collate the failure state information and the abnormality index with past failure case information and known failure pattern information, and extract response candidate procedures; generate a prompt sentence for input to a generative AI model based on the response candidate procedures, latest time-series data, and the abnormality index; input the generated prompt sentence to the generative AI model and receive, from the generative AI model, explanation information expressed in natural language and a plurality of response plan pieces of information; integrate the explanation information and the response plan pieces of information with the response candidate procedures, edit the integrated information as response procedure information having an execution order, an importance level, and constraint conditions, and generate presentation data for an operator and automatic execution data; notify the response procedure information to a terminal apparatus or a display apparatus, and acquire execution approval information or execution selection information from the terminal apparatus or the display apparatus; instruct, based on the execution approval information or the execution selection information, at least one of load distribution control, cooling control, power saving control, and configuration change control to the information processing apparatus group and the communication apparatus group via a control interface, and store an execution result as history information; and update the normal operation pattern and an abnormality determination criterion by using the history information and the explanation information, and reflect the updated normal operation pattern and the abnormality determination criterion in future failure prediction and response procedure generation. This enables the computer system to automatically close the loop from data acquisition and anomaly detection through AI-assisted response planning and controlled execution back to model updating, thereby reducing operator burden, improving the precision and timeliness of anomaly detection and remediation, and enhancing the overall availability, stability, and resource efficiency of the underlying computing infrastructure.

The term “processor” refers to one or more hardware circuits, such as a central processing unit or processing core, configured to execute instructions that implement the functions described in the claims.

The term “information processing apparatus group” refers to a plurality of computing devices, such as servers, storage devices, or virtual machines, that execute application programs and system software and provide information processing services.

The term “communication apparatus group” refers to a plurality of communication devices, such as switches, routers, or gateways, that forward, route, or otherwise process communication data between information processing apparatuses and external networks.

The term “operating state information” refers to information indicating a current operational condition of an apparatus, including at least one of a status of running processes, up/down state, throughput, response time, and error state.

The term “resource utilization information” refers to information indicating a usage level of hardware or software resources of an apparatus, including at least one of processor usage, memory usage, storage usage, and communication bandwidth usage.

The term “temperature information” refers to information indicating a temperature value associated with an apparatus or a physical environment of the apparatus, including at least one of an internal device temperature and an ambient temperature.

The term “electric power consumption information” refers to information indicating an amount of electric power consumed by an apparatus or a group of apparatuses over time.

The term “communication volume information” refers to information indicating an amount of communication traffic processed by an apparatus or a group of apparatuses over time, including at least one of packet counts and data transfer volumes.

The term “time-series data” refers to data that associates measurement values with corresponding time points or time intervals in chronological order.

The term “normal operation pattern” refers to a learned statistical or behavioral model that represents typical relationships and ranges of operating state information, resource utilization information, temperature information, electric power consumption information, and communication volume information during non-failure operation.

The term “abnormality index” refers to a numerical or categorical indicator computed based on a comparison between current or recent time-series data and the normal operation pattern, the indicator representing a degree or likelihood of abnormality.

The term “failure state information” refers to information describing a condition of an apparatus or a system at a time of failure occurrence or anomaly detection, including at least one of a failure time, an affected component, an error message, and an observed symptom.

The term “failure case information” refers to information describing past failure events, including at least one of failure state information, cause information, and response procedure information associated with each failure.

The term “failure pattern information” refers to generalized information representing typical combinations of conditions, metrics, and symptoms that characterize specific types of failures.

The term “response candidate procedures” refers to one or more preliminary sequences of actions that are identified as potentially effective for addressing a detected failure or anomaly, based on at least one of failure case information and failure pattern information.

The term “generative AI model” refers to a machine learning model configured to generate text or other data in response to an input prompt, the model being trained on large-scale data and capable of producing natural-language explanations and proposals.

The term “prompt sentence” refers to a structured natural-language or machine-readable text that encodes current and historical system conditions, constraints, and requests, and that is provided as input to a generative AI model.

The term “explanation information” refers to natural-language text generated by the generative AI model, the text describing at least one of a likely cause, a risk, or an effect related to a failure or anomaly.

The term “response plan pieces of information” refers to units of information generated by the generative AI model, each unit describing at least one candidate action, parameter, or sequence for addressing a failure or anomaly.

The term “response procedure information” refers to information that defines a concrete sequence of actions to be taken in response to a failure or anomaly, the information including at least an execution order, an importance level, and constraint conditions for each action.

The term “presentation data” refers to data formatted for display to an operator on a terminal apparatus or a display apparatus, the data including at least a summary of an incident and associated response procedure information.

The term “automatic execution data” refers to data formatted for direct use by control logic of the server to automatically execute actions specified in the response procedure information without manual intervention.

The term “terminal apparatus” refers to an electronic device operated by a user, such as a mobile terminal, a tablet, or a client computer, that can receive notifications and present information from the server and transmit user inputs to the server.

The term “display apparatus” refers to an electronic device or subsystem configured primarily to present visual information, such as a monitor or a dashboard device, which may be directly or indirectly connected to the server.

The term “execution approval information” refers to information input by an operator via a terminal apparatus or a display apparatus, the information explicitly authorizing execution of one or more actions included in the response procedure information.

The term “execution selection information” refers to information input by an operator via a terminal apparatus or a display apparatus, the information specifying which actions among a plurality of proposed actions are to be executed or not executed.

The term “control interface” refers to a hardware or software interface, including at least one of an application programming interface, a command interface, or a management protocol interface, through which the server can transmit control commands to the information processing apparatus group and the communication apparatus group.

The term “load distribution control” refers to control that redistributes processing load among a plurality of information processing apparatuses to alleviate overload or to balance resource utilization.

The term “cooling control” refers to control that adjusts cooling-related parameters, such as fan speed or cooling capacity, in order to manage temperature of apparatuses or their environment.

The term “power saving control” refers to control that reduces electric power consumption by adjusting at least one of device operating modes, activation states, or resource allocations.

The term “configuration change control” refers to control that modifies logical or physical configurations of apparatuses or services, including at least one of enabling or disabling components, changing routing or mapping, and altering resource assignments.

The term “history information” refers to information recording at least executed actions, execution times, success or failure results, and related conditions, accumulated across multiple incidents or control operations.

The term “operation rule information” refers to information that specifies policies, rules, and constraints governing how operation of the system should be conducted, including at least allowed actions, priority criteria, and scheduling constraints.

The term “safety standard information” refers to information that defines safety-related requirements and constraints, including at least limits on operations that may affect hardware integrity, data integrity, or service continuity.

The term “future failure prediction” refers to estimation or forecasting of potential future failures or anomalous states based on at least the normal operation pattern, the abnormality index, and the history information.

The term “response procedure generation” refers to a process of constructing response procedure information, including selection, ordering, and parameterization of actions, based on at least current conditions, historical data, model outputs, and operational constraints.

In one embodiment, a server implements the claimed system as a computer-implemented control platform for an information processing apparatus group and a communication apparatus group deployed in a data center or similar environment. The server includes at least one hardware processor, a main memory, a persistent storage device, and a network interface. The server executes an operating system such as a general-purpose server operating system, and executes application software that realizes the functional blocks described in the claims, including monitoring data acquisition, model learning, anomaly index computation, prompt sentence generation, generative AI interaction, response procedure generation, and control execution.

The server uses hardware monitoring interfaces of the information processing apparatus group and the communication apparatus group to acquire operating state information, resource utilization information, temperature information, electric power consumption information, and communication volume information. For example, the server uses a management interface (such as an out-of-band management bus), a management information protocol, and an operating system metrics library on each apparatus. The server acquires, as numerical values, metrics such as processor utilization, main memory utilization, storage I/O throughput, internal device temperature, rack inlet temperature, power draw per device or per rack, network interface throughput, and packet counts. The server associates each acquired metric value with a timestamp and an identifier of the corresponding apparatus and stores the resulting tuples as time-series data in a database residing on the storage device.

The server structures the time-series data in a relational or time-series database schema that includes at least device identifier fields, metric type fields, value fields, and time fields. The server maintains index structures over the time and device identifier fields such that retrieval of recent measurement windows is accelerated. By designing the database schema and index layout in this way, the server improves the speed of data retrieval for subsequent model computation as compared with a naive log file scan.

The server uses the stored time-series data to learn a normal operation pattern and to compute an abnormality index. In one embodiment, the server executes a statistical feature extraction procedure in which the server partitions the time-series data into fixed-length windows (for example, five-minute intervals) for each apparatus or apparatus group. For each window, the server computes feature values such as mean, maximum, minimum, standard deviation, and rate of change for each metric type. The server then normalizes these feature values using a scaling method, for example, subtracting a historical mean and dividing by a historical standard deviation per feature, to produce normalized feature vectors.

The server trains an anomaly detection model using the normalized feature vectors corresponding to periods labeled as normal operation. In one embodiment, the server uses an isolation-based ensemble model, in which the server constructs multiple random trees that partition the feature space, and computes anomaly scores based on path lengths in the trees. In another embodiment, the server uses a neural network model, such as an autoencoder, that includes an input layer corresponding to the feature dimensionality, one or more hidden layers, and an output layer that reconstructs the input. The server trains the autoencoder by minimizing a reconstruction error function, such as mean squared error between input and reconstructed output, and updates the weights of the neural network using an optimization method such as stochastic gradient descent or an adaptive variant. In still another embodiment, the server uses a recurrent neural network, such as a long short-term memory network, that processes sequences of feature vectors over time and predicts future values; the server then computes an abnormality index as a function of prediction error.

The server computes, during operation, an abnormality index for current data by applying the trained model to newly generated feature vectors. In the isolation-based model, the server computes an anomaly score by aggregating path length statistics; in the autoencoder-based model, the server computes a reconstruction error and compares the error to a threshold that has been set based on a percentile of training errors; in the recurrent model, the server computes a prediction error per metric and aggregates the errors into a scalar index. The server stores the abnormality index along with the corresponding time and apparatus identifier as part of the time-series database. By maintaining this learned normal operation pattern and associated abnormality index, the server improves the accuracy of anomaly detection for complex multi-metric interactions compared to fixed-rule threshold systems, thereby reducing false positives and false negatives.

The server also stores failure case information and failure pattern information in the database. The server records, for each historical failure, a set of fields including failure time, affected apparatus identifier, affected function, error messages, observed metric values and abnormality indices near the failure time, and a response procedure that was executed along with a success or failure result. The server generalizes failure pattern information by associating specific combinations of metric conditions, such as “processor utilization above a first threshold, temperature above a second threshold, and power consumption above a third threshold within a predefined time window,” with a type of failure such as “overload and thermal risk.”

The server collates newly computed abnormality indices and failure state information with the stored failure case information and failure pattern information to extract response candidate procedures. In one embodiment, the server executes a rule-based inference engine in which the server evaluates rules that match metric conditions and abnormality indices against stored patterns. In another embodiment, the server performs similarity search in the feature space by computing distances between the current feature vector and feature vectors associated with past failures stored in the database, and selects response procedures from the most similar past failures. The server thereby generates one or more response candidate procedures that describe sequences of possible control actions.

The server then generates a prompt sentence for input to a generative AI model. The server assembles current and recent metrics, abnormality indices, matched failure patterns, and response candidate procedures into a structured natural-language description. For example, the server generates a prompt sentence such as:

“A data center server currently has processor usage of 92 percent, internal temperature of 72 degrees Celsius, and power consumption of 4.5 kilowatts. Typical values for this time period are processor usage between 60 and 70 percent, temperature between 60 and 62 degrees Celsius, and power consumption of 3.0 kilowatts. Similar past incidents were resolved by increasing fan speed and redistributing workloads. As a data center operations assistant, analyze this situation, explain the likely causes, and propose a detailed, step-by-step mitigation plan that includes both immediate actions within 10 minutes and short-term actions within 24 hours. Prioritize safety and service continuity while also considering energy efficiency.”

In another example, the server generates a prompt sentence such as:

“When the temperature of a server is 10 degrees higher than normal, what cooling measures are required? The current server rack temperature is 72 degrees Celsius, while the typical maximum is 60 degrees Celsius. Suggest both immediate and long-term countermeasures.”

In still another example, the server generates a prompt sentence such as:

“Network traffic is expected to peak between 18:00 and 22:00 based on the last 30 days of hourly traffic data. Predict how network traffic will change during the next peak period and propose appropriate countermeasures for congestion mitigation.”

The server constructs the prompt sentence using a predefined template that explicitly includes numerical metric values, their historical baselines, and any constraints or objectives such as service level targets and energy efficiency targets. By automatically generating prompt sentences in a consistent format, the server reduces variability associated with manual question formulation and increases the quality of the input given to the generative AI model, thereby improving the relevance and precision of the generated responses.

The server transmits the generated prompt sentence to a generative AI model that is accessible via a network interface. In one embodiment, the server communicates with a language model deployed on a separate computing system, using an application programming interface over a secure communication protocol. The server sends the prompt sentence and receives back text that contains explanation information and response plan pieces of information. In another embodiment, the server executes the generative AI model locally on a separate processing device equipped with an accelerator, and exchanges data with that device via an internal network.

The server parses the received text to identify individual response plan pieces of information. For example, the server uses a simple structured format where the generative AI model outputs numbered steps, and the server identifies each line beginning with a number as a separate action. The server may also require the generative AI model, via the wording of the prompt sentence, to classify each proposed action into categories such as “automatic control,” “manual inspection,” or “configuration change,” and to specify any preconditions or expected side effects. The server then integrates the received response plan pieces of information with the previously extracted response candidate procedures. The server resolves conflicts by applying operation rule information and safety standard information stored in the database, for example, by discarding actions that would exceed defined temperature or power limits or violate maintenance scheduling policies.

The server finally constructs response procedure information that includes an execution order, an importance level, and constraint conditions for each action that remains after filtering. The server marks each action as either eligible for automatic execution by the server or designated as requiring manual execution by an operator. The server generates presentation data that encapsulates a summary of the incident and the response procedure information in a format suitable for display.

The server notifies the terminal of the presence of a new response procedure. The terminal is, for example, a mobile terminal or a client terminal that executes a management application. The server sends a notification message containing at least an incident identifier, a severity level, and a short description of the recommended actions. Upon receiving the notification, the terminal presents an alert to the user and obtains additional details from the server when the user opens the incident view. The terminal displays the explanation information generated by the generative AI model, including likely causes and risk assessments, along with the list of recommended actions, their execution order, their importance levels, and their classification into automatic and manual categories.

The user uses the terminal to review the recommended response procedure. The user may select which actions to approve for automatic execution and which actions to defer or modify. The terminal transmits execution approval information and execution selection information back to the server, including an indication of which actions are authorized for execution and any parameter adjustments specified by the user.

The server receives the execution approval information and the execution selection information and, based on those inputs, issues control commands to the information processing apparatus group and the communication apparatus group via a control interface. For example, the server issues load distribution control commands to an orchestration system to migrate workloads from one apparatus to another; the server issues cooling control commands to a management interface of a cooling subsystem to increase device fan speeds or to adjust cooling capacity; the server issues power saving control commands to change power states of certain apparatuses; and the server issues configuration change control commands to modify routing rules or resource assignments. The server logs the result of each control command, including success or failure codes and resulting metric changes, as history information in the database.

The server uses the history information and the explanation information to update the normal operation pattern and the abnormality determination criterion. For example, the server incorporates post-control metric values into the training dataset and recalculates thresholds for reconstruction error or anomaly scores to better reflect the improved operational baseline. The server also marks which combinations of metrics, abnormality indices, and response procedures led to successful remediation, and uses this information to adjust rule weights and to improve similarity metrics used in matching new incidents to past cases. By integrating execution results into the learning process, the server creates a feedback loop that continuously improves anomaly detection and response planning.

This configuration is not limited to simple automation of human decision making, because the server performs algorithmic transformations on large-scale telemetry data and uses learned models to refine control decisions in a manner that is not achievable by static rule sets. The server reduces computational overhead by using structured feature vectors and by performing model inference only on aggregated windows rather than on each raw sample. The server improves communication efficiency by sending only summarized metrics and prioritized recommendations to the terminal rather than raw telemetry streams. The server improves accuracy and speed of failure detection by computing abnormality indices that consider multi-metric temporal patterns and by updating thresholds based on feedback, so that detection can occur earlier and with fewer false alarms than conventional threshold-based systems.

The server also improves the functioning of the computing infrastructure by optimizing the timing and magnitude of control actions. For instance, by coordinating load distribution control and cooling control based on the output of both the anomaly detection model and the generative AI model, the server avoids unnecessary workload migrations and cooling adjustments, thereby reducing energy consumption and thermal stress on devices. This leads to extended hardware lifetime and reduced frequency of abrupt failures. The causal relationship between the described processing and the technical effect is that the learned normal operation pattern and abnormality index enable more precise identification of conditions under which a small control intervention achieves a large stabilizing effect, while the generative AI output refines the set of candidate interventions under explicit constraints.

In alternative embodiments, the server uses different model architectures or learning methods. For example, the server may employ a probabilistic graphical model to represent dependencies among metrics, and compute an abnormality index as a deviation from learned joint distributions. The server may apply a different training objective, such as maximizing likelihood of normal data under a density model, and compute negative log-likelihood as the abnormality index. The server may also alter the neural network architecture of the generative AI model used to produce explanations and plans, for example by employing a transformer-based sequence model with self-attention layers, in which the server specifies length and tokenization parameters to control computational cost.

In still further embodiments, the server implements part of the described functions on separate modules. For example, the server may delegate feature extraction and anomaly index computation to a dedicated analytics node and may delegate generative AI interaction to a separate AI node. The server coordinates data exchange among these nodes over an internal network using defined data structures, such as fixed-format records representing feature vectors and JSON-like text representing prompt sentences and model outputs. Regardless of these variations, the essential actions of acquiring metrics as time-series data, learning a normal operation pattern, computing an abnormality index, generating and providing a prompt sentence to a generative AI model, and using the combined outputs of anomaly detection and generative reasoning to control physical devices remain common.

The terminal and the user interact with the server to ensure that the overall system remains under human supervision where required, while still leveraging automated analysis and control. The terminal provides an interface through which the user can adjust operation rule information and safety standard information that the server uses to filter and prioritize AI-suggested actions. The user may, for example, configure maximum allowable temperature limits, critical application lists, and maintenance windows, which the server then incorporates into its rule sets and prompt sentence templates. This integration of human-specified constraints, learned patterns, and generative AI output enables the server to implement non-conventional sequences of actions that adapt over time and enhance the technical performance of the data center infrastructure.

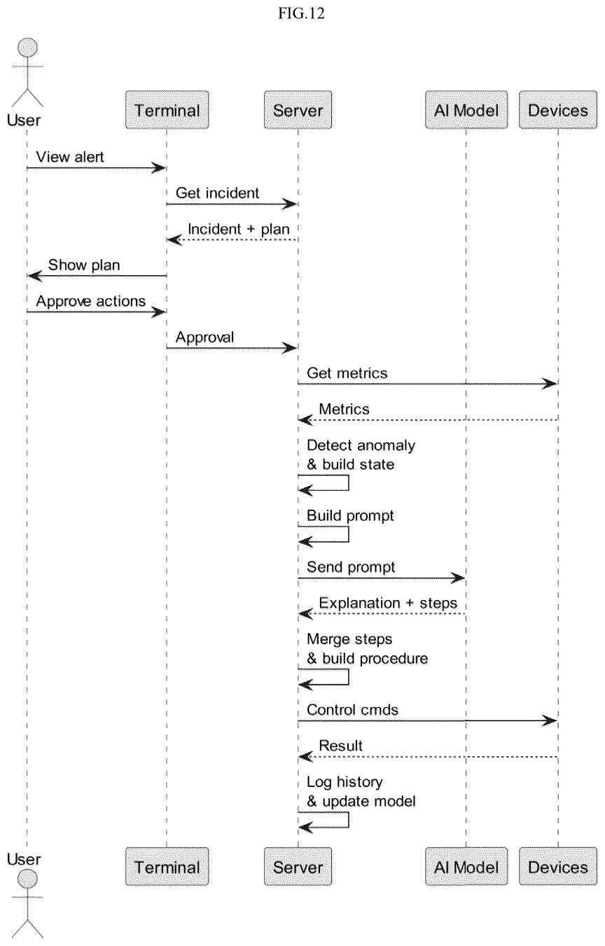

The following describes the processing flow using FIG. 12.

### Step 1:

The server acquires raw monitoring data from the information processing apparatus group and the communication apparatus group.

The input to this step is hardware and software telemetry accessible via management interfaces, such as processor utilization counters, memory usage counters, temperature sensor readings, power meter readings, and network interface statistics.

The server uses a management protocol or operating system interfaces to read these values periodically, for example every 30 seconds, and associates each value with a timestamp and a device identifier.

The output of this step is a set of raw metric records of the form (device ID, metric type, value, timestamp), which the server forwards to a storage module.

### Step 2:

The server stores the raw metric records as time-series data in a database.

The input to this step is the set of raw metric records generated in Step 1.

The server validates each record (for example, checking that values are within permissible ranges and that timestamps are not in the future), and discards or flags inconsistent records.

The server inserts valid records into time-series tables indexed by device ID and timestamp, and may aggregate multiple raw samples into a single record per interval.

The output of this step is a persistent time-series dataset that can be efficiently queried by time range and device identifier.

Step 3: The server constructs feature vectors representing recent behavior for each device or device group.

The input to this step is the stored time-series dataset from Step 2 over a training or analysis period.

The server partitions the time axis into fixed-length windows (for example, five minutes) for each device, and computes statistical descriptors such as mean, maximum, minimum, standard deviation, and rate of change for each metric (processor, memory, temperature, power, communication volume) within each window.

The server then normalizes these descriptors, for example by subtracting historical means and dividing by historical standard deviations per feature.

The output of this step is a collection of normalized feature vectors, each associated with a device ID and a time window.

### Step 4:

The server trains an anomaly detection model that represents a normal operation pattern. The input to this step is the collection of normalized feature vectors from Step 3 corresponding to periods labeled or assumed as normal.

The server feeds these feature vectors into a model training routine, such as an isolation-based anomaly detector, an autoencoder, or a recurrent neural network. The server iteratively adjusts model parameters to minimize a training loss (for example, reconstruction error or prediction error) or to optimize an internal separation criterion between typical and atypical samples.

The output of this step is a trained model object and associated parameters (for example, thresholds for anomaly scores), which the server stores in a model repository for later inference.

### Step 5:

The server computes an abnormality index in real time for current data using the trained model.

The input to this step is a sliding window of the most recent time-series data from Step 2 and the trained model from Step 4.

The server repeats the feature extraction and normalization of Step 3 for the current window, then applies the trained model to the current feature vector to obtain an anomaly-related quantity, such as a reconstruction error, a prediction error, or an anomaly score.

The server then converts this quantity into an abnormality index by applying a threshold function or scaling rule derived during training.

The output of this step is an abnormality index for each monitored device or device group at the current time, which the server records along with the corresponding metrics.

Step 6: The server detects potential failures and compiles failure state information.

The input to this step is the current metrics from Step 2 and the abnormality indices from

### Step 5.

The server compares each abnormality index with one or more thresholds corresponding to different severity levels, and checks whether particular metric conditions (for example, processor utilization above one threshold and temperature above another threshold) are simultaneously satisfied.

If these conditions are met, the server creates failure state information that includes at least the time, the affected device identifiers, the metric values, the abnormality indices, and any relevant error message data retrieved from system logs.

The output of this step is a structured failure state record that indicates an anomaly or failure candidate and that the server stores in a failure event table.

### Step 7:

The server matches the current failure state with stored failure case information and failure pattern information to extract response candidate procedures.

The input to this step is the current failure state record from Step 6 and the stored failure case and pattern data in the database.

The server evaluates rule conditions or similarity measures to find past failure cases whose metric patterns and abnormality indices resemble the current failure state, and retrieves the response procedures that were previously associated with successful outcomes for those cases.

The server optionally aggregates or filters these procedures according to relevance, frequency of success, and current constraints.

The output of this step is a set of response candidate procedures, each described as a sequence of potential actions with associated context.

### Step 8:

The server generates a prompt sentence for input to a generative AI model.

The input to this step is the current metrics and abnormality indices from Steps 2 and 5, and the response candidate procedures from Step 7.

The server constructs a natural-language text that summarizes the current state using explicit numerical values, describes typical historical ranges, cites similar past incidents and their outcomes, and includes any operational objectives and constraints (such as maintaining service levels and reducing power consumption).

The server embeds these details into a predefined template to form a prompt sentence. For example, the server may generate:

“A data center server currently has processor usage of 92 percent, internal temperature of 72 degrees Celsius, and power consumption of 4.5 kilowatts. Typical values for this time period are processor usage between 60 and 70 percent, temperature between 60 and 62 degrees Celsius, and power consumption of 3.0 kilowatts. Similar past incidents were resolved by increasing fan speed and redistributing workloads. As a data center operations assistant, analyze this situation, explain the likely causes, and propose a detailed, step-by-step mitigation plan that includes both immediate actions within 10 minutes and short-term actions within 24 hours. Prioritize safety and service continuity while also considering energy efficiency.”

The output of this step is at least one prompt sentence ready to be sent to the generative AI model.

### Step 9:

The server sends the prompt sentence to the generative AI model and obtains explanation information and response plan pieces of information.

The input to this step is the prompt sentence from Step 8.

The server transmits the prompt sentence to a generative AI model endpoint via a communication interface, specifying any parameters required by the endpoint. The generative AI model processes the text and returns a response containing explanatory text and a list or description of proposed actions.

The server receives the response and parses the text to identify individual steps, categories, and constraints described in the response.

The output of this step is explanation information describing likely causes and risks, and a set of response plan pieces of information, each representing a candidate action or set of actions.

### Step 10:

The server filters and integrates AI-suggested actions with the response candidate procedures to generate response procedure information.

The input to this step is the response candidate procedures from Step 7, the explanation information and response plan pieces from Step 9, and stored operation rule information and safety standard information.

The server evaluates each AI-suggested action against the operation rules and safety standards, and discards or modifies any action that conflicts with those constraints. The server then merges remaining AI-suggested actions with the historical response candidate procedures, resolves duplicates and conflicts, and assigns an execution order, an importance level, and constraint conditions to each action based on severity, dependencies, and resource impact.

The output of this step is response procedure information that specifies a structured list of actions, each with metadata indicating order, priority, eligibility for automatic execution, and any preconditions.

### Step 11:

The server generates presentation data and automatic execution data from the response procedure information and sends the presentation data to the terminal.

The input to this step is the response procedure information from Step 10.

The server formats the response procedure information into a human-readable form for display, including summaries, detailed steps, and graphical indications of severity and status, and simultaneously creates a machine-readable representation for direct use in control modules.

The server then sends a notification message with summary data to the terminal and makes the detailed presentation data available via an access interface.

The output of this step is a notification delivered to the terminal and a set of formatted data structures stored on the server that the terminal can retrieve for display.

### Step 12:

The terminal displays the incident details and response procedure information to the user and acquires execution approval information and execution selection information.

The input to this step is the notification and presentation data from Step 11.

The terminal requests the detailed incident information from the server and renders it in a user interface, including the explanation information from the generative AI model and the list of proposed actions with their order and importance.

The user reviews the displayed information on the terminal, selects which actions to approve for automatic execution, optionally adjusts parameters or marks some actions for manual execution, and confirms the selections. The terminal packages the user's decisions as execution approval information and execution selection information and sends them back to the server.

The output of this step is a structured representation of the user's approvals and selections transmitted to the server.

### Step 13:

The server executes approved automatic actions through the control interface and records execution results as history information.

The input to this step is the execution approval information and execution selection information from Step 12, and the automatic execution data derived in Step 11.

The server identifies all actions that have been approved for automatic execution and constructs corresponding control commands, such as commands to adjust load distribution, modify cooling parameters, change power states, or alter device configurations. The server sends these commands through the control interface to the appropriate devices or management systems, monitors responses, and determines success or failure.

The server records each executed action, along with execution time, target device, result, and any observed immediate changes in metrics, as history information in the database. The output of this step is an updated history dataset that links incidents, actions, and results.

### Step 14:

The server updates models and criteria for future detection and response based on the history information and explanation information.

The input to this step is the history information from Step 13, the explanation information from Step 9, and existing model parameters from Step 4.

The server enriches the training dataset with post-action metric values labeled as successful or unsuccessful remediation, and re-estimates parameters such as thresholds for abnormality indices or weights in similarity calculations for pattern matching. The server may retrain or fine-tune the anomaly detection model using an updated loss function that accounts for the success of past interventions and may adjust prompt sentence templates to emphasize metrics and conditions identified as important in previous explanations.

The output of this step is an updated normal operation pattern, updated abnormality determination criteria, and optionally updated prompt sentence templates, which the server uses in subsequent executions of Steps 3 through 10 to improve detection accuracy, response quality, and computational efficiency.

It is also possible to incorporate an emotion engine for estimating the user's emotions.

That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In large-scale information processing environments, conventional monitoring and incident management systems primarily focus on technical indicators, such as processor utilization, memory consumption, network traffic, response time, and error rate. These systems log such operational data and, upon detection of a failure, match the observed failure information against a rule base or a past-incident database to suggest a generic handling procedure. While this approach can identify and remediate many failures from a purely technical standpoint, it does not adequately capture or utilize the emotional state of end users affected by the failure. As a result, even technically minor incidents can trigger severe user anger, dissatisfaction, confusion, and anxiety, which in turn cause increased complaint volume, user churn, and reputational damage for the service provider.

Furthermore, in conventional systems, incident response messages and operator guidance are often manually crafted by human operators based on experience and intuition. This leads to several technical problems. First, the quality and consistency of response procedures and user communications vary significantly between operators, which reduces the reliability and repeatability of system operation. Second, the time required for manual analysis of logs, selection of past cases, and drafting of user-facing messages directly increases the mean time to resolution (MTTR) and prolongs periods of degraded user experience. Third, existing tools that integrate generative models typically accept only coarse failure summaries and return generic advice, without being driven by a rich, automatically assembled context derived from detailed operational metrics and quantified user emotions.

In addition, existing anomaly prediction mechanisms generally consider only operational metrics. They may detect increases in CPU usage or response time, but they do not predict how such technical changes will propagate into user emotions. Consequently, system operators cannot systematically perform preventive actions or communicate proactively with users in anticipation of emotional deterioration. The lack of a mechanism that jointly models the temporal evolution of operation state and user emotion, and that automatically translates such joint state into machine-generated procedures and messages, limits the ability of the computer system itself to optimize its incident handling behavior.

Accordingly, there is a need for a computer-implemented system that technically improves incident management by: (i) computing emotion scores from user inquiries and behavior logs in an automated and reproducible manner; (ii) identifying similar past incidents based on both technical features and emotional features; (iii) automatically constructing prompt sentences that encode rich situational context and supplying these prompts to a generative AI model; and (iv) automatically parsing AI-generated responses into structured operator procedures and user-facing messages. Such a system should further integrate a prediction model that uses both operational metrics and emotion scores to detect early signs of emotional deterioration and to drive the automatic generation of preventive technical actions and advance user notices. By embedding these capabilities within the server-side processing pipeline, the invention aims to improve the functioning of the underlying computer system itself in terms of automated analysis, decision support, and communication, rather than merely automating a human mental process.

The specific processing by the specific processing unit 290 of the data processing device 12 in Example 2 is realized by the following means.

The present invention provides a server comprising a processor, a storage device, and a communication interface, wherein the processor is configured to acquire operation state information and failure information via an input unit, store the acquired information in the storage device, and learn, based on the stored operation state information, a normal operation pattern and an abnormal state determination criterion for an information processing apparatus group; acquire, from a terminal, at least one of an inquiry text of a user, an evaluation information item of the user, and an operation history of the user, apply an emotion analysis model including a natural language processing model and a behavior analysis model to the acquired information, calculate an emotion score representing at least anger, dissatisfaction, confusion, anxiety, satisfaction, and neutrality, and store the emotion score in association with user identification information and time information; compare, at a time of occurrence of a failure, current failure information and a current emotion score with past failure information and past emotion scores stored in the storage device, determine similarity of at least failure content and emotional state, and extract a similar failure case based on the determined similarity; generate, based on situation information including the similar failure case, current operation state information, the current failure information, and the current emotion score, a prompt sentence in a natural language for a generative AI model, input the prompt sentence to the generative AI model, and acquire, from the generative AI model, a response text including a technical failure handling procedure and a user-oriented message according to an emotional state; analyze the acquired response text, extract, from the response text, technical failure handling procedure information for an operator and user-oriented message information, and transmit the technical failure handling procedure information to an operator terminal and transmit the user-oriented message information to a user terminal so that the information is displayed or sent on the user terminal; and detect, based on a temporal transition of the operation state information and a temporal transition of the emotion scores stored in the storage device, a sign of emotional deterioration by using a prediction model configured to output a probability of occurrence of emotional deterioration at a future time, generate, based on a prediction result of the prediction model and current operation state information, a preventive prompt sentence for the generative AI model, input the preventive prompt sentence to the generative AI model, acquire a preventive technical countermeasure procedure and an advance guidance message from the generative AI model, and transmit, via a notification unit, a preventive guidance notification based on the preventive technical countermeasure procedure and the advance guidance message to at least one terminal. This enables the computer-implemented incident management system to technically improve its operation by automatically integrating multi-modal emotion estimation with operational metrics, by leveraging generative AI models through structured prompt sentences to derive consistent and context-aware operator procedures and user communications, and by proactively controlling incident handling behavior based on predicted emotional impact, thereby reducing manual workload, shortening response time, and stabilizing the quality and consistency of system operation.

The term “system” refers to an arrangement of at least one server, at least one terminal, and associated communication paths, in which hardware components and software components cooperate to execute the processing described in the claims.

The term “server” refers to an information processing apparatus or a group of information processing apparatuses including at least one processor, a storage device, and a communication interface, the server being configured to execute programs that implement acquisition, storage, analysis, learning, generation, and notification processing as recited in the claims.

The term “processor” refers to a hardware processing unit, such as a central processing unit or an execution core, or a set of such units, which executes computer-readable instructions to perform arithmetic operations, logical operations, data transfer operations, and control operations defined by one or more programs.

The term “storage device” refers to a hardware storage resource, such as a semiconductor memory, a magnetic storage medium, or an optical storage medium, or a combination thereof, which stores operation state information, failure information, user information, model parameters, prompt sentences, and response texts for later retrieval and processing.

The term “communication interface” refers to a hardware and software component that enables the server to send and receive data over a communication network using standardized protocols, and that allows interaction between the server and one or more terminals.

The term “terminal” refers to an information processing apparatus operated by an operator or a user, including at least a processor, a display, an input device, and a communication interface, the terminal being configured to display information received from the server and to transmit user inputs, inquiry texts, evaluation information, and operation histories to the server.

The term “input unit” refers to a functional component realized by hardware and software of the server and/or terminal that receives operation state information, failure information, user inquiry texts, evaluation information, and operation histories from internal or external sources and supplies such information to the processor for further processing.

The term “operation state information” refers to data indicating a running condition of an information processing apparatus group, the data including at least one of operation status, processing resource usage, storage resource usage, communication amount, response time, error rate, and log information collected over time.

The term “failure information” refers to data indicating an abnormal event or fault in an information processing apparatus group, the data including at least one of a failure occurrence time, an affected component or service, an error code, an error message, a summary of observed symptoms, and report content received from an operator or a user.

The term “information processing apparatus group” refers to a set of one or more servers, storage systems, network devices, and application components that cooperate to provide a computing service or an application function to users.

The term “normal operation pattern” refers to a representation of typical behavior of operation state information when the information processing apparatus group is operating correctly, including reference values, distributions, and temporal profiles of metrics used for comparison with abnormal states.

The term “abnormal state determination criterion” refers to a rule, threshold, or learned model parameter that distinguishes an abnormal state from a normal state based on operation state information and optionally other features.

The term “user” refers to an end entity, human or system, that accesses a service provided by the information processing apparatus group via a terminal, and that may generate inquiry texts, evaluation information, and operation histories.

The term “operator” refers to a human or system responsible for monitoring, controlling, or maintaining the information processing apparatus group, the operator using a terminal to view notifications and execute countermeasures.

The term “inquiry text” refers to text data generated by a user and transmitted from a terminal to the server, the text data describing at least a problem, a question, or a request regarding the service.

The term “evaluation information” refers to data expressing a user's subjective evaluation of a service, including at least one of a rating value, an emotion icon, or a selection from predefined evaluation options.

The term “operation history” refers to a sequence of interaction events between a user and a terminal or a service, including at least one of button clicks, form submissions, page transitions, error screen displays, and timestamps of such events.

The term “emotion analysis model” refers to a statistical model or machine learning model that receives at least one of inquiry texts, evaluation information, and operation histories as input, and outputs emotion scores corresponding to multiple emotion categories.

The term “natural language processing model” refers to a machine learning model or algorithm that processes text data, performs at least tokenization, feature extraction, or embedding computation, and contributes to classification or estimation of emotion or other properties from text.

The term “behavior analysis model” refers to a machine learning model or rule set that processes features derived from operation histories, such as repeated clicks or dwell times, and outputs estimates or correction values related to behavioral indicators of emotions, such as frustration or confusion.

The term “emotion score” refers to numerical information, expressed as a scalar or vector, representing a degree or probability of one or more emotion categories including at least anger, dissatisfaction, confusion, anxiety, satisfaction, and neutrality for a user at a given time.

The term “user identification information” refers to data that uniquely or quasi-uniquely identifies a user or a user account, such as a user ID, a session ID, or a combination thereof.

The term “time information” refers to data indicating a time point or time interval associated with operation state information, failure information, or an emotion score, such as a timestamp or a time range.

The term “similar failure case” refers to a past failure instance stored in the storage device that is determined to be similar to a current failure based on comparison of at least failure content features and emotion score features.

The term “situation information” refers to a collection of contextual data describing a current operational and emotional state, including at least one of current operation state information, current failure information, current emotion scores, and information about one or more similar failure cases.

The term “generative AI model” refers to a machine learning model, such as a large language model or other generative model, that receives a prompt sentence as input and outputs a text response that is syntactically and semantically coherent in a natural language.

The term “prompt sentence” refers to a natural language text string that encodes instructions and situation information and is supplied as input to the generative AI model in order to obtain a desired response text.

The term “response text” refers to natural language text generated by the generative AI model in response to a prompt sentence, the text including at least a technical failure handling procedure and a user-oriented message.

The term “technical failure handling procedure” refers to a set of actions or steps, expressed in text, that specify how an operator or automated mechanism should operate or configure the information processing apparatus group in order to mitigate or resolve a failure.

The term “user-oriented message” refers to text content intended to be presented to a user, including at least one of an apology, an explanation of a failure, a status update, a recovery forecast, or a compensation description.

The term “operator terminal” refers to a terminal operated by an operator and configured to receive technical failure handling procedure information from the server and to present such information via a user interface.

The term “user terminal” refers to a terminal operated by a user and configured to receive user-oriented message information from the server and to present such information via a user interface or other output channel.

The term “prediction model” refers to a statistical model or machine learning model configured to receive features derived from operation state information and emotion scores over time and to output a probability of occurrence of emotional deterioration at a future time.

The term “emotional deterioration” refers to a state in which one or more emotion scores indicative of negative emotions, such as anger, dissatisfaction, confusion, or anxiety, increase beyond a predefined threshold or exhibit a worsening trend over time.

The term “preventive prompt sentence” refers to a prompt sentence that describes a predicted future risk of emotional deterioration together with current operation state information and that requests the generative AI model to generate preventive technical countermeasures and advance guidance messages.

The term “preventive technical countermeasure procedure” refers to a set of actions or steps, generated by the generative AI model based on a preventive prompt sentence, that are to be executed before or during early stages of a failure to prevent or mitigate emotional deterioration and system impact.

The term “advance guidance message” refers to user-oriented message content generated by the generative AI model in response to a preventive prompt sentence, the content being intended for communication to users before or during early stages of a failure in order to reduce emotional deterioration.

The term “notification unit” refers to a functional component realized by hardware and software of the server that controls transmission of technical failure handling procedure information, user-oriented message information, preventive technical countermeasure procedures, and advance guidance messages to one or more terminals via a communication interface.

The term “structured data” refers to data that is organized according to a predefined format or schema, such as records with named fields in a table or a hierarchical representation in a markup or data-interchange format, and that can be programmatically processed for display, storage, or further computation.

In one embodiment, a server, a terminal, and a user cooperate to implement the invention.

A server operates on general-purpose computing hardware, such as one or more rack-mounted computers each including a multicore central processing unit, a main memory, a persistent storage subsystem, and a network interface controller. The server executes a server-class operating system such as a Linux-based operating system, and runs middleware including an HTTP server, an application execution environment (for example, a scripting language runtime or a virtual machine), a relational database management system, a log collection and analysis framework, a system metrics collection tool, a machine learning framework, and a client library for interacting with a generative AI model via an external or internal interface.

A terminal operates on user-side or operator-side hardware, such as a mobile information terminal, a handheld communication device, a portable computing device, or a stationary computing device, each including a display, an input device such as a keyboard, a pointing device or a touch panel, and optionally an audio input/output device. The terminal executes a web browser or a native application and establishes secure communication with the server using an encrypted communication protocol.

A user interacts with the terminal to access services provided by an information processing apparatus group managed by the server. The user inputs natural language inquiry texts, evaluation values, and other feedback, and performs interactive operations such as button clicks, form inputs, and navigation operations. The user views technical status messages and user-oriented messages on the terminal.

A server stores system configuration data, operation state information, failure information, user inquiry information, emotion scores, and model parameters in a storage device that may be composed of semiconductor memories and magnetic or other nonvolatile media. The server defines database tables, indexes, and relations for operation metrics, incidents, user inquiries, operation logs, emotion scores, and AI-generated outputs. The server thereby enables efficient indexed access, joins, and aggregations over large volumes of time-series and textual data.

A terminal transmits operation state information and failure information to the server as structured messages. The terminal organizes the data into records with fields such as system identifier, timestamp, metric names and values, incident identifier, error code, affected component, and summary. The terminal sends these records via a hypertext transfer protocol over a secured channel. The terminal also records user-side interaction events, such as repeated clicking on a particular user interface element, transitions between specific views, dwell times on error screens, and resubmissions of input forms, and transmits these events as an operation history to the server.

A server parses incoming messages and writes the parsed data into appropriate tables in the storage device. The server normalizes timestamps into a unified time base, assigns session identifiers, and transforms logs into key-value structures. The server uses the relational database management system to enforce referential integrity and to maintain consistency of associations among operation metrics, incidents, user inquiries, and emotion scores. The server thus improves data management by structuring heterogeneous information into well-defined schemas, enabling computationally efficient queries and joins that are not feasible with ad-hoc file-based logging. A server applies a natural language processing model and a behavior analysis model as parts of an emotion analysis model. In one embodiment, the natural language processing model includes a deep neural network of the transformer type. The transformer comprises an input embedding layer, multiple self-attention layers, feed-forward layers, and a classification head.

The input embedding layer maps token identifiers corresponding to words or subwords of an inquiry text into continuous-valued vectors. The self-attention layers compute attention weights between tokens, using scaled dot-product attention, and propagate contextual information across positions. The feed-forward layers perform nonlinear transformations using activation functions such as rectified linear units. The classification head maps the final contextual representations into a vector of logits for emotion categories, including anger, dissatisfaction, confusion, anxiety, satisfaction, and neutrality. The server applies a softmax function to these logits to obtain emotion probability values.

A server trains the natural language processing model using labeled training data composed of inquiry texts paired with ground-truth emotion labels. The server uses a cross-entropy loss function to quantify the difference between predicted emotion probabilities and target one-hot vectors. The server performs weight updates using a stochastic gradient-based optimization algorithm. The server may use techniques such as mini-batch training, gradient clipping, and learning-rate scheduling to stabilize and accelerate convergence. By pre-training on large generic text corpora and fine-tuning on domain-specific data, the natural language processing model attains high accuracy in emotion categorization without requiring handcrafted rules for each possible wording.

A server implements a behavior analysis model that receives numerical features derived from operation histories. The server aggregates operation events over fixed or adaptive time windows per user or per session and calculates features such as the count of clicks on a specific element, the cumulative time spent on screens labeled as error screens, the number of form resubmissions, and the number of back-and-forth navigations between two views. In one embodiment, the behavior analysis model includes a gradient-boosted decision tree ensemble trained to output adjustments to frustration-related and confusion-related emotion components. The server trains this model using supervised learning, with labels representing the degree of observed user frustration or confusion, derived from user feedback or support outcomes. The server uses an objective function such as a logistic loss or squared error, and updates tree structures by iteratively adding trees that correct residual errors. This approach allows the behavior analysis model to capture nonlinear interactions between behavioral features and emotional outcomes.

A server combines outputs of the natural language processing model and the behavior analysis model to produce an emotion score vector. The server aligns emotion categories between the two models, scales and normalizes adjustment values, and performs a weighted combination, such as a linear combination followed by bounding or clipping. The server stores the resulting emotion score, along with user identification information and timestamp, in an emotion score table. By integrating textual and behavioral signals, the server increases robustness and precision of emotion estimation in comparison with systems that rely solely on text or solely on simple threshold rules, thereby reducing misclassification and enabling more precise downstream decisions.

A server learns normal operation patterns and abnormal state determination criteria by analyzing accumulated operation state information. The server partitions operation metrics by time segment, system role, or workload level and computes statistical descriptors such as mean values, variances, and quantiles for CPU utilization, response time, and error rate. The server uses these descriptors as baseline profiles. The server also trains an anomaly detection model, which may be implemented as an autoencoder neural network, a clustering-based model, or a supervised classifier, to distinguish normal from abnormal patterns. For example, in one embodiment the server trains an autoencoder neural network with a bottleneck layer on normal operation data. The server minimizes a reconstruction error, such as mean squared error between input and reconstructed metrics, using a gradient-based optimizer. During operation, the server computes the reconstruction error for new data; errors exceeding a threshold indicate anomalies. This technical approach improves sensitivity to subtle multidimensional anomalies beyond simple thresholding, increasing detection accuracy and decreasing false alarms.

A server correlates failures with emotion scores by linking failure information and emotion score records via incident identifiers and timestamps. The server aggregates emotion scores during time windows surrounding each failure and calculates statistics such as average anger score and percentage of users with dissatisfaction score above a threshold. The server stores these indicators as attributes of past failure cases. This structured association of technical state and emotional state enables the server to later compare incidents in both spaces, which is not achievable with conventional logs that treat user emotions, if captured at all, as unstructured comments.

A server determines a similar failure case for a newly occurring failure. The server first selects candidate past cases based on technical attributes such as error code, affected component, and operation metrics signatures, using index-based queries or similarity search. The server then retrieves corresponding aggregated emotion vectors for the candidates and for the current incident. The server computes similarity measures, such as cosine similarity or Mahalanobis distance, over emotion vectors and over normalized technical feature vectors, and combines these values using a configurable weighting scheme. The server selects the past case with the highest combined similarity or a set of top cases. Because the server uses a dual-space similarity metric, the selected cases reflect not only technical resemblance but also similarity in user emotional reaction, providing more relevant precedents for both technical and communication strategies.

A server constructs a prompt sentence in natural language to query a generative AI model. The server gathers situation information, including the current failure information, current operation state metrics, current emotion statistics, and summaries of selected similar failure cases. The server uses a template comprising fixed phrases and placeholders. The server performs string substitution and concatenation to embed actual data values into the template. For example, in one embodiment the server generates a prompt sentence such as:

“The following system incident is occurring.
Error code: E201
Incident content: Payment processing is timing out and users cannot complete their payments.
System state: The application server CPU usage is 40% higher than usual, and the database response time is 300 ms worse than the average.
User emotions: 50% of users have an anger score of 0.85 or higher, and 60% of users have a dissatisfaction score of 0.8 or higher.
Past cases: In similar incidents, improving the payment retry logic and distributing coupons to affected users were effective.

In this situation,
(1) List detailed, step-by-step technical mitigation procedures that system operators should execute immediately.
(2) Create three example Japanese messages for apology and compensation to send to users with high anger and dissatisfaction.
(3) Propose three mid- to long-term improvements from the perspectives of system design and UX design to prevent similar emotional deterioration.”

A server sends the prompt sentence to a generative AI model via an application programming interface. In one embodiment, the generative AI model is a large language model of the transformer type running on a separate computation cluster. The server transmits the prompt sentence and parameters controlling sampling behavior, such as temperature and maximum output length. The generative AI model performs multi-head self-attention and feed-forward processing over the prompt tokens and generates a probability distribution over output tokens at each time step. The generative AI model then produces a response text including distinct sections corresponding to technical procedures and user-oriented messages.

A server parses the response text. The server identifies structural markers such as numbered lists, section headers, or delimiter phrases. The server may apply regular expressions or a lightweight rule-based parser to detect boundaries between operator-facing content and user-facing content. The server splits the text into segments corresponding to individual steps or message templates and then maps each segment into structured records with fields such as step description, precondition, expected effect, message title, and message body. As a result, the server converts free-form output of the generative AI model into machine-processable structured data. This enables the server to integrate the generated content into dashboards, automation systems, and messaging pipelines without human reformatting, reducing latency and human error.

A server defines and trains a prediction model that outputs a probability of future emotional deterioration. The server constructs time-series feature vectors from operation metrics and aggregated emotion scores, including recent values, moving averages, and rate of change. In one embodiment, the prediction model includes a recurrent neural network such as a long short-term memory network. The network receives sequences of feature vectors and outputs, for each future horizon, a probability that a negative emotion ratio will exceed a configured threshold. The server trains this network using historical data where future emotional outcomes are known, minimizing a loss function such as binary cross-entropy. This configuration enables the server to forecast not only whether a technical incident may occur but also how user emotions are likely to evolve, allowing proactive adjustments.

A server uses the prediction model to generate a preventive prompt sentence before a severe incident or emotional spike occurs. For example, when the model predicts that the proportion of users with anger score above 0.7 is likely to exceed a specified percentage within a certain time interval, the server composes a prompt such as:
“Currently, CPU usage has been 30% higher than usual for more than 60 minutes, and the response delay of the search function is 250 ms worse than the average.

Based on past statistics, if this state continues, the percentage of users with an anger score of 0.7 or higher is predicted to reach 35% in 30 minutes.

Based on this prediction,
(1) Propose preventive technical actions that can be executed immediately (such as scale-out, cache strengthening, or function throttling).
(2) Create three example Japanese advance notice messages to send to users to prevent emotional deterioration.”

A server submits this preventive prompt sentence to the generative AI model and receives a response including preventive technical countermeasure procedures and advance guidance messages. The server converts these into structured records similar to those for reactive procedures and messages.

A terminal receives operator-facing procedure records from the server and renders them in a graphical operator console. The terminal displays steps as list items, each with summary and detail, and provides interaction controls to mark steps as completed or trigger automated actions, such as invoking an orchestration interface of the server or a control interface of the information processing apparatus group. By integrating generated procedures into an actionable interface, the terminal contributes to reducing reaction time and execution errors.

A terminal also receives user-oriented message records and presents them in a message selection and editing interface. An operator uses the interface to select or adjust messages and specify distribution scopes and channels. The terminal then transmits configuration choices back to the server, which in turn forwards messages through appropriate communication infrastructures, such as in-app notification services, push notification services, or email transfer systems. As a result, user-facing communication is generated and distributed in a consistent and context-aware manner, grounded on real-time analysis of operation and emotion data.

A user reads the resulting notifications and may change behavior accordingly, such as delaying usage, retrying at suggested times, or refraining from issuing additional complaints. These reactions lead to changes in operation histories and subsequent emotion scores, which the server captures. Thus, the system creates a feedback loop in which server, terminal, and user interactions are measured, analyzed, and improved over time based on technical indicators and emotional indicators.

A server achieves technical improvements over prior systems in several ways. First, the server integrates a dual-modality emotion analysis pipeline, combining transformer-based language modeling with behavior-based models, which yields higher emotion classification accuracy and robustness than rule-based or single-modality approaches. This directly improves the quality of downstream decision making. Second, the server implements a dual-space similarity search over both technical features and emotion features, improving the relevance of past case retrieval and enabling nontrivial mappings between current incidents and historically effective mitigation strategies. Third, the server formalizes the generation of prompt sentences via templates that embed structured situation information, resulting in repeatable and machine-controllable use of generative AI models. This differs from ad-hoc manual prompt construction and ensures that the generative AI model receives consistent, enriched context, improving the relevance and specificity of generated responses.

Moreover, the server structures and parses generative AI model outputs into machine-readable data, which can be programmatically linked to control interfaces and notification systems. This architecture allows incident responses, preventive actions, and communication strategies to be automatically orchestrated, monitored, and evaluated. The integration of prediction models that use both operational metrics and emotion scores provides an additional improvement: the server can preemptively alter configuration of the information processing apparatus group or adjust user communications before severe emotional deterioration occurs, thereby reducing peak loads on support channels and improving stability of resource utilization.

Alternative embodiments are also possible. A server may employ different neural network architectures for the emotion analysis model, such as convolutional neural networks for text or sequence-to-sequence models, provided that they produce emotion scores compatible with the described framework. A server may use alternative anomaly detection or prediction algorithms, such as Gaussian mixture models, one-class support vector machines, or temporal convolutional networks, as long as the models accept operation state and emotion features and output predictions of abnormal states or emotional deterioration. A server may host the generative AI model locally or connect to a remote generative AI service, and may adapt prompt templates to various languages or domains. A terminal may implement user interfaces in different frameworks and may be realized as a headless client that relays notifications to other devices.

In all such embodiments, a server, a terminal, and a user operate together so that operational data and user emotional reactions are captured, quantified, analyzed, and used to generate prompt sentences for a generative AI model and to apply the resulting procedures and messages in a technically structured manner. This configuration improves the underlying computer technology by enhancing data management, improving accuracy and speed of incident analysis and prediction, reducing manual and inconsistent handling, and enabling proactive and adaptive control over system operation and user communication.

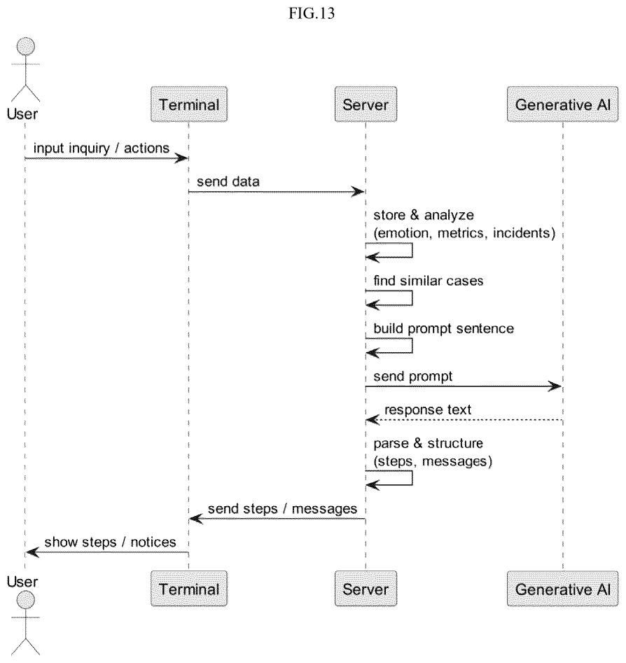

The following describes the processing flow using FIG. 13.

Step 1: User inputs inquiry, feedback, and operation commands on the terminal.

User types an inquiry sentence such as “I cannot log in” or “Payment does not complete” into a text box, selects an evaluation such as a star rating or an emotion icon, and presses a send button. The input of this step is raw user text and UI operations received via the terminal's input devices. The output of this step is UI events and text strings held temporarily in the terminal's memory.

### Step 2:

Terminal structures user inputs and operation history.

Terminal converts the raw text, selected evaluation, and UI events into structured records, for example records containing fields such as ‘user_id’, ‘session_id’, ‘timestamp’, ‘page_id’, ‘event_type’, ‘input_text’, and ‘rating_value’. Terminal aggregates multiple events into small batches over a time window. The input of this step is the unstructured UI events and text from Step 1; the terminal performs data formatting and field assignment operations to produce JSON-like structured data as the output.

### Step 3:

Terminal transmits structured data to the server.

Terminal sends batched structured records containing inquiry texts, evaluation information, operation histories, operation metrics, and failure information to the server using an encrypted communication protocol. The input of this step is the structured records produced in Step 2; the terminal performs network communication and serialization, and the output is corresponding request messages delivered to the server.

### Step 4:

Server receives and validates incoming messages.

Server accepts HTTP or similar requests via a communication interface, parses the message bodies, and verifies authentication tokens, required fields, and basic constraints such as field lengths and types. The input of this step is the serialized request payloads arriving from the terminal; the server performs decoding, schema validation, and error checking, and outputs validated payload objects to the application logic, or error responses if validation fails.

### Step 5:

Server stores operation state information, failure information, and user records.

Server maps validated payload fields to relational database columns using an ORM or SQL layer and executes insert or update commands for tables such as an operation metrics table, an incidents table, a user inquiries table, and an operation logs table. The input of this step is the validated payload objects from Step 4; the server performs data normalization, key generation, and transactional writes, and outputs persistent database records that can be queried by key or time.

### Step 6:

Server pre-processes inquiry texts for the emotion analysis model.

Server reads unprocessed inquiry records from the user inquiries table, extracts text fields, and applies a tokenizer and normalizer. Server converts the text into sequences of token identifiers according to a vocabulary of a natural language processing model and pads or truncates the sequences to a fixed length. The input of this step is raw inquiry text read from the database; the server performs string normalization, tokenization, and integer encoding, and the output is batches of fixed-length integer vectors ready for neural network processing.

### Step 7:

Server computes text-based emotion scores.

Server loads an emotion classification neural network, such as a transformer-based model, and feeds the token sequences into the network. The neural network performs embedding, self-attention, and feed-forward computations to produce logits for emotion categories. Server applies a softmax function to obtain probability values for anger, dissatisfaction, confusion, anxiety, satisfaction, and neutrality. The input of this step is the encoded token sequences from Step 6; the server performs matrix multiplications, non-linear activations, and normalization operations, and the output is an emotion probability vector for each inquiry.

### Step 8:

Server stores text-based emotion scores in the emotion score table.

Server associates each emotion probability vector with corresponding user identifiers and timestamps, then writes records into an emotion scores table. The input of this step is the emotion vectors from Step 7 and metadata from the user inquiries table; the server performs data aggregation and mapping, and the output is a set of stored emotion score entries accessible by user or time.

### Step 9:

Server derives behavioral features from operation history.

Server retrieves operation logs for each user and groups them by user and time window. Server counts repeated clicks on the same element, measures dwell time on error pages, counts form resubmissions, and calculates other behavioral metrics. The input of this step is raw event sequences from the operation logs table; the server performs grouping, counting, and interval calculations, and the output is numerical feature vectors summarizing user behavior in each time window.

### Step 10:

Server refines emotion scores with behavior analysis models.

Server loads one or more behavior analysis models, such as gradient-boosted decision trees, and inputs behavioral feature vectors to obtain adjustment values for frustration and confusion. Server fetches the corresponding text-based emotion scores and combines them with the adjustment values using a defined formula, for example weighted addition followed by clipping to a valid range. The input of this step is both the behavioral features from Step 9 and the text-based emotion vectors from Step 8; the server performs model inference and vector arithmetic, and the output is refined emotion vectors representing the current emotional state per user.

### Step 11:

Server updates emotion score records with refined emotion vectors.

Server writes the refined emotion vectors back to the emotion scores table, updating records or adding new entries for the relevant time windows. The input of this step is the refined emotion vectors from Step 10; the server performs database update operations, and the output is an updated set of emotion records that integrate both text and behavioral information.

### Step 12:

Server learns normal operation patterns and abnormal criteria.

Server periodically extracts operation metrics during labeled normal operation periods and computes statistics such as mean, variance, and quantiles per metric and time segment. Server also trains anomaly detection models using these metrics, for example by feeding metric vectors into an autoencoder network and minimizing reconstruction error on normal data. The input of this step is historical operation metric records; the server performs statistical aggregation and model training with gradient-based optimization, and the output is baseline metric profiles and trained anomaly detection parameters stored in the storage device.

### Step 13:

Server links failures and emotion scores into past failure cases.

Server correlates failure records from the incidents table with emotion scores from the emotion scores table based on incident time windows and user associations. Server computes incident-level emotional statistics, such as average anger score and the ratio of high-dissatisfaction users, and stores these as attributes of each failure case. The input of this step is failure information and emotion score records; the server performs time-window joins and aggregate calculations, and the output is enriched failure case records that contain both technical and emotional attributes.

### Step 14:

Server detects a new failure and current emotional status.

Server monitors failure information for new incident entries or anomaly notifications.

When a new failure is detected, server retrieves current operation metrics and aggregated current emotion vectors for affected users. The input of this step is the latest incident record and recent metric and emotion data; the server performs range queries and aggregation, and the output is a structured description of the current failure and its associated emotional state.

### Step 15:

Server searches for similar past failure cases.

Server selects candidate past cases based on technical similarity, such as matching error codes or affected components, and then refines selection using emotional similarity by comparing current emotion vectors to past incident emotion vectors with a similarity function. The input of this step is the current failure description from Step 14 and the past failure case records from Step 13; the server performs similarity scoring and ranking computations, and the output is one or more similar past failure cases with associated mitigation histories.

### Step 16:

Server constructs a prompt sentence for the generative AI model.

Server assembles situation information including the current error code, failure description, operation metrics deviations, current emotional statistics, and summaries of effective actions from similar past cases. Server fills predefined placeholders in a natural-language template using string concatenation and formatting. The input of this step is situation information and template definitions; the server performs string processing and template substitution, and the output is a prompt sentence describing the situation and requesting specific outputs. An example is:

“The following system incident is occurring.
Error code: E201
Incident content: Payment processing is timing out and users cannot complete their payments.
System state: The application server CPU usage is 40% higher than usual, and the database response time is 300 ms worse than the average.
User emotions: 50% of users have an anger score of 0.85 or higher, and 60% of users have a dissatisfaction score of 0.8 or higher.
Past cases: In similar incidents, improving the payment retry logic and distributing coupons to affected users were effective.

In this situation,
(1) List detailed, step-by-step technical mitigation procedures that system operators should execute immediately.
(2) Create three example Japanese messages for apology and compensation to send to users with high anger and dissatisfaction.
(3) Propose three mid- to long-term improvements from the perspectives of system design and UX design to prevent similar emotional deterioration.”

### Step 17:

Server sends the prompt sentence to the generative AI model and receives a response text.

Server transmits the prompt sentence to a generative AI model via an API, specifying generation parameters like temperature and maximum length. The generative AI model generates a response text that includes technical procedures and user-oriented messages. The input of this step is the prompt sentence from Step 16; the server performs network request handling and awaits the model's output, and the output is a natural-language response text returned from the generative AI model.

### Step 18:

Server parses and structures the generative AI model's response.

Server analyzes the response text, identifies sections for operator procedures and user messages using patterns such as numbered lists and headings, and splits the text into discrete items. Server converts each item into a structured record containing fields such as title, step description, and message body. The input of this step is the raw response text from Step 17; the server performs text parsing, pattern matching, and mapping to structured representations, and the output is a set of structured operator procedure records and user message template records.

### Step 19:

Server sends operator procedures to the operator terminal.

Server packages the operator-facing structured records into a response for the operator terminal, including step sequences, priorities, and optional machine-readable action identifiers. The input of this step is the operator procedure records from Step 18; the server performs serialization and communication, and the output is an API response that the operator terminal can render as an incident handling plan.

### Step 20:

Terminal displays the operator dashboard and accepts operator actions.

Terminal receives structured procedures, renders them as lists or cards in a dashboard interface, and provides controls for viewing details, marking steps as completed, or triggering automated actions. The input of this step is the structured procedure data from Step 19; the terminal performs GUI rendering and event handling, and the output is display updates and operator actions, such as button clicks, that are sent back to the server.

### Step 21:

Server prepares and sends user-oriented messages to user terminals.

Server takes the user message templates from Step 18 and, based on operator selections and configuration, determines target user groups and delivery channels. Server personalizes message content if needed and sends notifications to user terminals or to messaging infrastructures. The input of this step is the user message templates and operator configuration; the server performs user segmentation, message instantiation, and communication, and the output is message payloads delivered to user terminals or external message systems.

### Step 22:

User receives and reacts to notifications on the terminal.

User views apology and explanation messages on the terminal through pop-ups, banners, or other UI elements, and may choose to retry operations, delay usage, or provide additional feedback. The input of this step is the notifications delivered in Step 21; the user performs interpretation and possible further interactions, and the output is new operation events and feedback that reenter the system via Step 1 and Step 2.

### Step 23:

Server predicts emotional deterioration based on temporal evolution.

Server periodically aggregates recent operation metrics and emotion scores into time-series feature vectors and inputs them into a trained prediction model. The model outputs probabilities that negative emotion ratios will exceed configured thresholds in future time windows. The input of this step is sequences of recent operation and emotion data; the server performs time-series aggregation and model inference, and the output is predicted risk values for emotional deterioration.

### Step 24:

Server constructs a preventive prompt sentence and queries the generative AI model.

When a predicted risk exceeds a threshold, server composes a preventive prompt sentence that describes the current technical state and the forecasted emotional risk and requests preventive actions and advance guidance messages. The input of this step is the prediction results from Step 23 and current metrics; the server performs template filling as in Step 16, and the output is a preventive prompt sentence sent to the generative AI model to obtain preventive countermeasures and user messages.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In large-scale information communication facilities, operators are required to monitor complex technical states such as resource utilization, temperature, power consumption, and network traffic, and to respond quickly to failures or performance anomalies. Conventional operation support systems typically rely on static rules or pre-defined procedures that are generated solely from technical telemetry. These systems analyze numerical metrics and log data, and then display uniform alerts and fixed troubleshooting flows, regardless of who the current operator is or in what cognitive or emotional state that operator is working.

As the complexity and scale of managed infrastructures increase, this uniform, operator-agnostic approach leads to several concrete technical problems. First, when an operator is under high stress, is confused, or is fatigued, the operator is more likely to misinterpret dense, technically worded instructions, skip critical steps, or perform actions in the wrong order. These mis-operations can cause longer incident resolution times, secondary failures, or unnecessary service interruptions. From a computer system perspective, this translates into unstable control loops between monitoring components and control components, increased rollback operations, and higher error rates in automated execution pipelines.

Second, the emergence of generative AI models has enabled automatic generation of natural-language operation procedures based on current technical states. However, existing uses of generative AI models generally construct prompt sentences only from machine state (for example, anomaly type, affected component, or metric values), without incorporating dynamic information about the operator's emotional state or interaction behavior. As a result, the generated responses are not tailored to the operator's current cognitive load or expertise level. For example, a beginner in a confused, high-stress state may receive overly concise, jargon-heavy instructions, while an experienced, calm engineer may receive long, verbose explanations that slow down decision making. This mismatch reduces the effective throughput of the system, because the human-computer interaction path becomes a bottleneck in the feedback control loop of the infrastructure.

Third, conventional systems rarely structure the human-facing UI behavior as a function of an estimated emotional state. Even if some systems use basic role-based views (for example, “beginner mode” versus “expert mode”), they generally do not couple UI adaptation with real-time estimates derived from multimodal operator data such as voice tone, text content, and detailed operation logs. As a result, the user interface cannot adapt dynamically to sudden changes in stress or confusion (for example, when a major incident begins), and the overall system cannot reduce human-induced error rates at the time when those errors are most likely. This limitation undermines the reliability and robustness of computer-implemented operation support workflows.

Accordingly, there is a need for a computer-implemented operation support technique that integrates (i) anomaly detection based on operational state data, (ii) estimation of an operator's emotional state based on multimodal interaction data, (iii) generation of prompt sentences for a generative AI model that reflect both technical and emotional context, and (iv) dynamic control of the presentation and granularity of AI-generated countermeasure procedures based on the emotional state. By closing this loop in a machine-executable manner, it becomes possible to technically improve the behavior of the overall computer system: reducing mis-operations, stabilizing control flows, shortening recovery time, and increasing the effective reliability and throughput of the infrastructure management process.

The specific processing by the specific processing unit 290 of the data processing device 12 in Application Example 2 is realized by the following means.

The present invention provides a server comprising a processor and a storage device, the processor being configured to acquire operational state data from a plurality of detection devices provided in an information communication facility, normalize and store the operational state data as time-series data in the storage device, learn a normal operational pattern by executing statistical processing or machine learning processing on the stored operational state data, and determine an abnormal state based on a deviation from the normal operational pattern; to acquire at least one of voice data, character data, and operation history data transmitted from an information processing terminal operated by a user, to extract acoustic feature data from the voice data by signal processing, to extract linguistic feature data from the character data by natural language processing, to extract operation feature data including operation frequency, error operation count, and non-operation time from the operation history data by behavioral analysis, to estimate an integrated emotional state of the user based on the acoustic feature data, the linguistic feature data, and the operation feature data, and to store an estimation result as state information for each user in the storage device; to generate, in accordance with the abnormal state and the emotional state, a prompt sentence written in natural language that includes content of the abnormal state, a state of a target device, and the emotional state of the user, and that further includes conditions or instructions for causing a generative AI model to generate response content; to input the generated prompt sentence into the generative AI model, to obtain response information written in natural language from the generative AI model, to analyze the response information to extract information including countermeasure procedures for the abnormal state, configuration change contents, and cautions, and to generate countermeasure candidate information as structured data and store the countermeasure candidate information in the storage device; to control, based on the countermeasure candidate information and the emotional state, a display format, an information amount, and a procedure segmentation method for presentation on the information processing terminal, such that, in a high-stress or confused emotional state, the countermeasure procedures are presented stepwise with reduced information per screen and confirmation operations before execution, and, in a calm and experienced emotional state, the countermeasure procedures are presented in an aggregated list format with related operational state data; and to acquire an operation control instruction input by the user via the information processing terminal, to execute, based on the operation control instruction, control processing including at least one of operational setting control, resource allocation control, load balancing control, and cooling control for the information communication facility through a management interface, and to transmit an execution result to the information processing terminal. This enables the computer-implemented operation support system to dynamically adapt both the generation of prompt sentences for the generative AI model and the presentation and execution of countermeasures to the operator's real-time emotional state, thereby technically improving system behavior by reducing human-induced errors, stabilizing control flows, and shortening anomaly recovery time in the managed information communication facility.

The term “information communication facility” refers to a collection of interconnected information processing equipment, storage equipment, communication equipment, and associated peripheral equipment that collectively perform data processing, data storage, and data transmission and reception.

The term “detection device” refers to a hardware or software component configured to measure a physical quantity or logical quantity related to an information processing device or communication device, such as processor utilization, memory usage, temperature, power consumption, or network traffic, and to output the measurement result as an electrical signal or digital data.

The term “operational state data” refers to time-series data representing an operating condition or performance state of an information communication facility, including at least processor utilization, memory usage, temperature, power consumption, and communication volume acquired from a plurality of detection devices.

The term “normal operational pattern” refers to a statistical or model-based representation of a typical or expected range of operational state data under non-failure conditions, learned from historical operational state data by statistical processing or machine learning processing.

The term “abnormal state” refers to a state of an information communication facility in which current operational state data deviates from the normal operational pattern by more than a threshold or satisfies a predefined abnormality condition, indicating a potential failure, performance degradation, or risk condition.

The term “information processing terminal” refers to a computing device operated by a user and communicatively connected to a server, the computing device being configured to display operation support information, to receive user input, and to transmit user-related data and control instructions to the server.

The term “voice data” refers to digitized acoustic data representing speech uttered by a user or other sound captured at the information processing terminal and transmitted to the server. The term “character data” refers to digital data representing text input by a user via an information processing terminal, including chat messages, command strings, and other textual input.

The term “operation history data” refers to digital data representing a chronological record of user operations performed via an information processing terminal, including at least button clicks, menu selections, error occurrences, screen transitions, and timestamps thereof. The term “acoustic feature data” refers to numerical feature vectors extracted from voice data by signal processing, including, for example, spectral features, cepstral coefficients, pitch, energy, and speech rate, which are usable as input to an emotion estimation model.

The term “linguistic feature data” refers to numerical representations of character data obtained by natural language processing, including token-level or sentence-level embeddings, classification features, or other text-derived features usable as input to an emotion estimation model.

The term “operation feature data” refers to numerical features derived from operation history data, including at least operation frequency, error operation count, non-operation time, repeated navigation patterns, and other behavioral metrics usable as input to an emotion estimation model.

The term “emotional state” refers to information representing a psychological state of a user, expressed as one or more labels or scores such as stress level, confusion level, fatigue level, confidence level, or calmness level, estimated based on at least one of acoustic feature data, linguistic feature data, and operation feature data.

The term “state information for each user” refers to data stored in a storage device that associates a user identifier with an estimated emotional state and, optionally, with related scores, timestamps, and historical records.

The term “generative AI model” refers to a machine learning model, implemented for example as a neural network, that is configured to generate output data such as natural-language text based on input data including at least a prompt sentence.

The term “prompt sentence” refers to natural-language input data supplied to a generative AI model, the input data including at least a description of an abnormal state, a description of a target device state, and a description of a user emotional state, and further including conditions or instructions controlling the content, style, or format of response content to be generated by the generative AI model.

The term “response information” refers to natural-language text or equivalent data output by a generative AI model in response to a prompt sentence, the text or data including proposals for countermeasure procedures, configuration changes, cautions, or other operation support information.

The term “countermeasure candidate information” refers to structured data representing one or more proposed responses to an abnormal state, the data including at least a set of countermeasure procedures, configuration change contents, and cautions derived from response information generated by a generative AI model.

The term “display format” refers to parameters that define how information is visually presented on a screen of an information processing terminal, including layout, grouping, ordering, emphasis, and visual style of textual and graphical elements.

The term “information amount” refers to a quantity or density of information presented at one time on a display screen, such as a number of steps, a length of textual explanation, or a number of data elements simultaneously shown.

The term “procedure segmentation method” refers to a rule or algorithm for dividing a series of countermeasure steps into one or more groups or screens, including at least the number of steps shown per screen and the order in which steps are presented.

The term “operation control instruction” refers to data input by a user via an information processing terminal that specifies a desired control action for an information communication facility, including at least an action type, a target resource, and one or more control parameters.

The term “management interface” refers to an interface, such as an application programming interface, command-line interface, or management protocol, through which a server can issue control commands to configure or operate components of an information communication facility.

The term “operational setting control” refers to processing that modifies configuration parameters related to operation of components in an information communication facility, such as threshold values, scheduling parameters, or mode settings.

The term “resource allocation control” refers to processing that adjusts allocation of computing, storage, or communication resources among components or services in an information communication facility.

The term “load balancing control” refers to processing that redistributes processing load or network traffic among multiple components or paths in an information communication facility in order to avoid concentration of load or to improve performance.

The term “cooling control” refers to processing that adjusts operating parameters of cooling equipment or temperature-related settings in an information communication facility to influence thermal conditions of equipment.

The term “time-series data” refers to data representing values of one or more metrics indexed by time, stored in such a way that chronological changes in the metrics can be analyzed.

The term “statistical processing” refers to computational processing that analyzes data using statistical methods, including at least calculation of averages, variances, trends, and thresholds for the purpose of characterizing normal and abnormal behavior.

The term “machine learning processing” refers to computational processing in which a model having parameters is trained or applied using data, such that the model learns patterns from the data and can output predictions, classifications, or anomaly scores.

The term “structured data” refers to data organized according to a predefined schema or format, including at least key-value pairs, records, or hierarchical objects, which allows programmatic access to elements such as individual steps, parameters, and warnings.

In one embodiment, a system includes a server and one or more terminals connected via a communication network. The server includes at least one processor and at least one memory device, and the terminal includes at least one processor, at least one memory device, and a display device. The server and the terminal execute computer programs that implement the functions described below.

The server operates as a centralized operation support apparatus for an information communication facility. The server is implemented on general-purpose server hardware, such as a rack-mounted information processing apparatus equipped with multi-core processors, main memory, non-volatile storage, and network interface controllers. The server executes an operating system such as a server-oriented operating system, a web server such as a general-purpose HTTP server, an application framework such as a web application framework, and a database management system such as a relational database management system.

The terminal operates as an operation console. The terminal is implemented on a general-purpose information processing terminal, such as a personal computer, workstation, or tablet device, executing a client operating system and a web browser such as a general-purpose browser. The terminal also includes input devices such as a keyboard, a pointing device, and optionally a microphone and camera.

The server acquires operational state data from a plurality of detection devices installed in the information communication facility. The detection devices include, for example, embedded sensor modules on computing nodes, storage nodes, and communication devices, and software agents executing on operating systems of those nodes. The server communicates with the detection devices by using a management protocol, such as a network management protocol, or a proprietary agent protocol. The server receives numerical values representing processor utilization, memory usage, device temperature, power consumption, and communication volume as digital data.

The server stores the operational state data in a time-series structure. The server writes each measurement as a record in a table of the relational database, such as a table having fields including device identifier, metric type, value, and timestamp. The server normalizes the values, for example by converting different units into unified units (such as converting bytes to megabytes, or converting raw sensor counts to degrees Celsius), and by scaling values into a common numeric range when necessary. The server thereby forms time-series data that are directly usable as input to statistical and machine-learning algorithms.

The server learns a normal operational pattern from the accumulated operational state data. The server uses numerical computation libraries, such as statistical computation libraries running on the server, to compute for each metric and each device at least a moving average, a standard deviation, and a seasonal trend (for example, daily or weekly periodicity). The server constructs feature vectors for each time window for each device, such as vectors including recent averages, slopes, and deviations from historical baselines.

The server executes a machine learning model for anomaly detection using a machine learning framework such as a neural-network framework or a general-purpose machine-learning library. In one embodiment, the server trains a one-class classification model, such as a one-class support vector machine or an autoencoder neural network, on historical operational state data labeled as normal. The server defines an objective function such as a reconstruction error or a margin-based loss and uses gradient-based optimization to update model parameters, including weights and biases of hidden layers. The server optionally applies data augmentation, such as adding small noise to normal samples or time-shifting time-series windows, to improve robustness of the model.

The server uses the learned model to compute anomaly scores for new operational state data. The server inputs the feature vectors of recent measurements into the trained model and obtains anomaly scores, such as reconstruction error values in the case of an autoencoder, or distance values in the case of a one-class classifier. The server compares each anomaly score with a threshold, which is determined based on a quantile of the training data distribution or based on a statistical criterion. The server determines whether each state is normal or abnormal according to the threshold, and further assigns an anomaly type based on which metric or combination of metrics contributes most to the anomaly score. The server thereby detects technical anomalies such as processor overload, abnormal temperature rise, sudden power consumption increase, or traffic spike.

The terminal collects user-related data while a user operates the console. The terminal captures voice data when the user permits voice collection. The terminal activates a microphone device via a media input interface of the browser, performs analog-to-digital conversion by using an audio driver, and encodes the sampled data into a compressed digital audio format. The terminal sends the encoded voice data to the server at predetermined intervals or when the user terminates voice input.

The terminal collects character data representing text input produced by the user. The terminal listens to input events from text fields on the operation console screen, such as chat input areas or command input forms. The terminal records each confirmed text input, such as when the user presses an enter key or selects a send button, as a text data element containing a string and a timestamp.

The terminal additionally records operation history data. The terminal logs significant user interactions on the GUI, such as button clicks, menu selections, changes in configuration parameters, error pop-ups, and screen transitions. The terminal associates each event with identifiers of the screen and UI elements, as well as timestamps and optionally contextual information such as the current anomaly being displayed. The terminal periodically bundles the voice data, character data, and operation history data into a structured payload, such as a JSON object with nested elements, and transmits this payload to the server via a secure communication protocol.

The server estimates an emotional state of the user based on multimodal user-related data. The server first processes voice data using an audio processing library. The server decodes the compressed audio stream, resamples the waveform to a common sampling rate, and segments the audio into fixed-length frames. For each frame, the server calculates acoustic features, such as Mel-frequency cepstral coefficients, spectral centroid, pitch, energy, and speech rate. The server constructs acoustic feature vectors and normalizes them by subtracting a mean vector and dividing by a standard deviation vector computed from training data.

The server inputs the acoustic feature vectors into an emotion classification neural network. In one embodiment, the server uses a convolutional neural network followed by a recurrent neural network, such as a long short-term memory network, to capture both local spectral patterns and temporal dynamics. The server defines an output layer whose units correspond to emotional dimensions such as stress, tension, and agitation. The server trains the network on labeled audio data by minimizing a loss function such as a cross-entropy loss or a mean-squared error between predicted emotion scores and ground-truth labels. The server updates weights by using a gradient descent algorithm with backpropagation.

The server performs natural language processing on the character data. The server tokenizes the text string into subword units and maps these tokens to embedding vectors using a pretrained language model. The server uses either the last-layer embeddings or pooled sentence representations as linguistic feature data. The server inputs these features into a classifier that outputs probabilities over text-based emotions, such as confusion, anxiety, or confidence. The classifier can be implemented as a shallow feed-forward network fine-tuned on labeled text data, or as a linear layer directly on top of the pretrained model representations.

The server derives operation feature data from operation history data. The server aggregates events in sliding time windows and computes, for each window, measurable features such as click frequency, number of repeated clicks on the same control, number of invalid operations, number of backward screen transitions, and cumulative idle duration. The server inputs these aggregated metrics into a machine learning model such as a gradient-boosted decision tree model or a neural network. The model outputs numerical estimates of fatigue, confusion, or operational instability.

The server integrates acoustic, linguistic, and operation-based emotion estimates into a unified emotional state. The server uses a meta-model that takes as input the vectors of modality-specific scores and outputs a combined emotional label and confidence. The meta-model can be a rule-based system in which rules assign labels based on thresholds in different dimensions, or a small neural network trained to predict overall states such as “high stress and confused” or “calm and experienced” given the modality-specific scores. The server writes the resulting emotional state into a user state table in the database, associating it with a user identifier and time, and also stores the most recent state in an in-memory cache for real-time access.

The server generates a prompt sentence for a generative AI model based on both the abnormal technical state and the estimated emotional state. The server obtains the latest anomalies that are relevant to the user's current view, such as anomalies affecting devices shown on a dashboard. The server aggregates anomaly attributes including anomaly type, metric values, affected devices, and estimated impact. The server then retrieves the current emotional state label and associated scores for the user.

The server constructs a prompt sentence by using a template-based generator. The server selects a template according to anomaly type and inserts the specific anomaly parameters. For a high-temperature anomaly with a stressed, confused user, the server may generate a prompt sentence such as:

“The temperature of a specific group of servers in the data center is 10 degrees Celsius higher than usual.

The operator has a high stress level and appears to be confused.

Explain three cooling countermeasures that can be executed step by step by a beginner. Avoid technical jargon as much as possible.

For each step, clearly describe ‘what to do’ and ‘why it is necessary’.”

For a case where network traffic is predicted to increase and the user is calm and experienced, the server may generate a prompt sentence such as:

“Network traffic is expected to reach twice the normal level during the next hour. The operator is experienced and calm.

For a professional network engineer, propose three concrete countermeasures using bandwidth control, traffic shaping, and rerouting.

Present the measures as concise bullet points.

For each measure, briefly describe the expected effect and the associated risks.” For a rapid increase in power consumption with a fatigued user prone to errors, the server may generate a prompt sentence such as:

“The power consumption has increased to 1.5 times the 30-day average.

The operator is fatigued and tends to make operational mistakes.

Propose three energy-saving countermeasures that can be executed by selecting options in a GUI, without complex manual commands.

For each countermeasure, specify concrete recommended settings (for example, CPU utilization limit, number of target servers, and schedule time).

Explain the operation steps in at most five simple steps per countermeasure.”

The server thereby systematically adjusts the style, granularity, and structure of the prompt sentence according to the emotional state, by applying programmable rules that determine instructions such as “avoid technical jargon”, “use step-by-step explanations”, or “summarize in concise bullet points”.

The server transmits the generated prompt sentence to a generative AI model. The server uses an API client that sends the prompt sentence as input to a text generation endpoint. The generative AI model is implemented as a neural network, for example a transformer-based language model with multiple layers of self-attention and feed-forward sublayers. The model has been trained on large corpora of text data to learn probability distributions over sequences of tokens. In one embodiment, the server sets generation parameters, such as maximum length of output, temperature, and top-k or top-p sampling values, to control randomness and determinism of the output.

The server receives response information from the generative AI model as natural-language text. The server stores the raw text and then parses it into structured countermeasure candidate information. The server applies parsing rules that look for common structures such as numbered lists, step headings, parameter mentions, and explicit warning phrases. The server divides the response into one or more countermeasure procedures, and for each procedure, extracts a sequence of steps, each with an action description and, where present, a rationale. The server also extracts any recommended configuration values, such as specific numeric settings, and warning statements such as “be careful not to exceed a certain threshold”.

The server encodes the parsed content into a structured data object. The server uses, for instance, an internal object or a serialized representation that contains arrays of procedures and steps, as well as separate fields for configuration values and warning messages. The server stores this object in the database, associated with the anomaly that triggered it and the user session that requested it. The structured representation allows the server to present, filter, and reuse countermeasure candidate information efficiently.

The terminal presents the countermeasure candidate information according to the emotional state. When the user is in a high-stress or confused state, the terminal enters a guided mode. In this mode, the terminal displays only a small number of steps, such as one step per screen, with clear labels and large fonts. The terminal uses short, plain-language descriptions derived from the structured data. The terminal requires the user to perform a confirmation operation, such as clicking a “Confirm and execute” button, before initiating a potentially critical operation. The terminal may also show an additional warning dialog for operations that are marked in the structured data as high risk.

When the user is in a calm and experienced state, the terminal enters an expert mode. In this mode, the terminal displays the entire list of procedures and steps on one or a small number of screens, in a compact list format. The terminal also displays associated time-series charts for relevant metrics, such as processor utilization or temperature, using a graph rendering library in the browser. The terminal enables the user to quickly scan the proposed countermeasures and correlate them with current metric trends.

The user interacts with the terminal to select and confirm specific operational actions. The user in guided mode goes through the steps sequentially and chooses whether to execute each proposed action. The user in expert mode may select multiple steps or procedures to execute together, and may adjust suggested parameters using input fields or sliders.

The terminal translates user selections into operation control instructions and sends them to the server. The terminal constructs a control command containing, for each selected action, an action type, identifiers of target devices, and parameter values. The terminal sends this control command to the server via a control API.

The server receives and validates the control commands. The server checks authentication and authorization data to ensure that the user has permission to execute the requested actions. The server also checks that parameter values fall within permitted ranges and do not violate safety constraints stored in configuration tables. If validation succeeds, the server maps the action types to specific operations on the information communication facility.

The server executes control processing by invoking management interfaces of underlying systems. For resource allocation and load balancing, the server calls infrastructure management APIs or orchestrators to modify routing rules, distribution weights, or virtual machine resource limits. For cooling control, the server calls cooling system APIs or low-level control interfaces that adjust fan speeds, coolant flow, or air-conditioning setpoints. The server monitors responses from these management interfaces and collects success or failure information, including error codes and messages. The server then records execution logs and sends an execution result back to the terminal.

This system produces technical effects beyond mere automation of human work. By combining multimodal emotion estimation with anomaly detection and adaptive generative AI prompting, the server reduces the probability of human-induced mis-operations under stress. The server controls the structure of interactions so that, in situations where error risk is high, the system constrains the amount and form of information presented, enforces step-by-step confirmations, and thereby reduces accidental execution of incorrect commands. This directly improves reliability and stability of control loops in the information communication facility. Furthermore, by converting free-form generative AI output into structured countermeasure candidate information, the server improves the computer's ability to manage and reuse operation procedures. The structured representation allows better indexing, caching, and selective presentation of steps, which reduces communication load and rendering overhead on terminals, and facilitates efficient logging and analysis of which recommendations are most effective. Also, since the server learns normal operational patterns and anomaly detection thresholds from data, the system can detect and respond to subtle deviations faster and more accurately than a system relying only on static rules.

The described architecture improves computer technology itself. The use of a specific multimodal pipeline—consisting of audio feature extraction, neural network-based emotion classification, text-based sentiment analysis, and operation-log-based behavior analysis—enables the server to estimate emotional states in real time and feed these into prompt generation. This integration allows the server to automatically tailor machine-human interactions, which changes the behavior of the overall distributed system in a way that reduces latency to effective action and decreases error rates. The system thereby improves processing speed, decision accuracy, and data management within the operation-support computer environment.

Alternative embodiments are possible. The server may employ different types of anomaly detection models, such as isolation forest, clustering-based models, or probabilistic graphical models. The server may adopt different neural network architectures for emotion estimation, such as transformer-based encoders for audio or multimodal fusion networks that jointly encode voice, text, and operation features. The generative AI model may be hosted externally or internally, and may be fine-tuned on domain-specific operation manuals. The system may also be extended to control additional physical subsystems, such as power distribution, access control, or environmental monitoring devices, through the same unified framework, while applying the same principles of technical-state-plus-emotional-state-driven prompt generation and adaptive presentation.

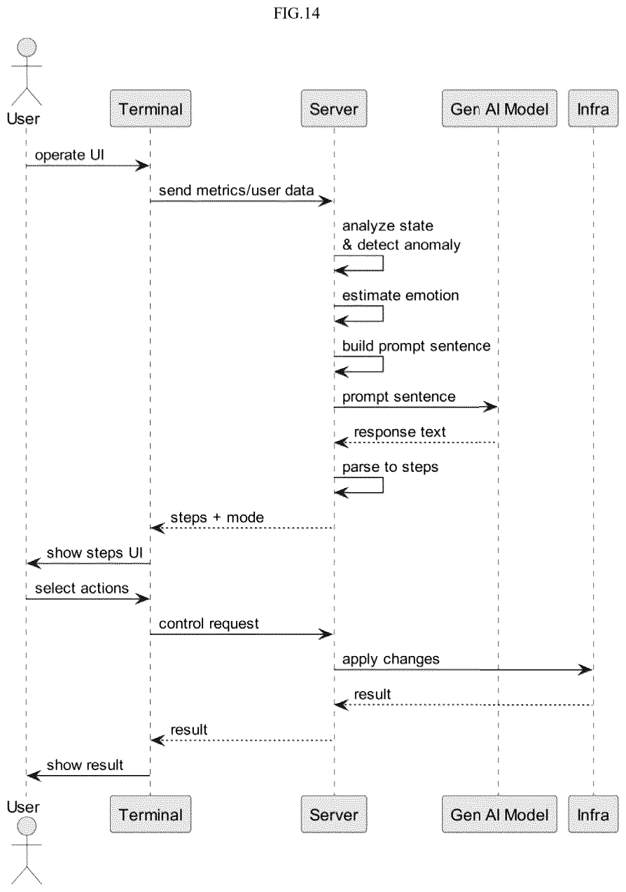

The following describes the processing flow using FIG. 14.

### Step 1:

The server acquires operational state data from detection devices in the information communication facility.

The input is raw measurement signals or numeric values output by hardware or software detection devices, including processor utilization, memory usage, temperature, power consumption, and communication volume, associated with device identifiers. The server uses a management protocol or agent software to send polling requests and receive responses containing these values. The server converts the input into normalized numeric values by performing unit conversion (for example, bytes to megabytes, raw sensor counts to degrees Celsius) and scaling, attaches timestamps and device identifiers, and constructs time-series records. The output is a set of normalized operational state records that the server writes into a time-series table of a relational database.

### Step 2:

The server learns a normal operational pattern from accumulated operational state data and detects abnormal states.

The input is historical operational state records retrieved from the database over one or more time windows for each device and metric. The server uses numerical libraries to compute statistical features such as moving averages, standard deviations, slopes, and seasonal baselines, and aggregates these into feature vectors per device and time window. The server feeds the feature vectors into a machine learning model, such as an autoencoder or one-class classifier, trained to represent normal behavior. The server computes anomaly scores, compares them with thresholds, and classifies each state as normal or abnormal, while determining an anomaly type based on contributing metrics. The output is a set of anomaly events containing device identifiers, anomaly types, metric snapshots, anomaly scores, and detection times, which the server stores in an anomaly event table.

### Step 3:

The terminal captures user voice, text, and operation history data during console operation and sends them to the server.

The input is user actions and speech at the terminal: spoken utterances captured by a microphone, keystrokes in text fields, and GUI interactions such as button clicks and screen transitions. The terminal uses browser media APIs to sample and encode voice data, listens for text input events to collect character data, and registers event handlers in the GUI to log operation history data with timestamps and element identifiers. The terminal packages audio chunks, text entries, and operation events into a structured payload, serializes it, and transmits it to the server over a secure network connection. The output is a user data request message delivered to the server's user-state collection API.

### Step 4:

The server extracts multimodal features from user data and estimates the user's emotional state.

The input is the user data payload containing voice data, character data, and operation history data for a given user session. The server decodes and resamples voice data, segments it into frames, and computes acoustic feature vectors such as cepstral coefficients, pitch, energy, and speech rate. The server tokenizes character data, maps tokens to embeddings via a language model, and derives linguistic feature vectors. The server aggregates operation history data into time-windowed metrics such as click frequency, error operation count, back-and-forth navigation count, and idle duration to form operation feature vectors. The server feeds each type of feature vector into corresponding trained models, such as a neural network for acoustic data, a classifier for text data, and a machine learning model for operation data, to obtain modality-specific emotion scores. The server combines these scores using a rule engine or meta-model to output a unified emotional state label and confidence values. The output is a user emotional state record that the server stores in a user state table and caches for real-time use.

### Step 5:

The server selects relevant anomaly events and the current emotional state as context for prompt sentence generation.

The input is recent anomaly event records in the database and the latest emotional state record associated with the current user. The server filters anomaly events by time range, device scope, or correlation with the user's current dashboard view, and retrieves descriptive metadata for affected devices. The server retrieves the emotional label and scores from the user state storage. The server composes a context object that includes fields such as anomaly type, metric values, device descriptions, impact estimates, and emotional state information. The output is a structured anomaly-and-emotion context object that will be consumed by the prompt generation logic.

### Step 6:

The server generates a prompt sentence for a generative AI model based on the context.

The input is the anomaly-and-emotion context object produced in Step 5. The server selects a template corresponding to the anomaly type (for example, cooling, load balancing, network traffic, or power consumption) and chooses style directives based on the emotional state (for example, beginner-friendly and stepwise for high stress, or concise and technical for calm and experienced). The server fills template placeholders with concrete values from the context, such as “temperature is 10 degrees Celsius higher than usual” or “traffic is predicted to double in the next hour,” and appends instructions about explanation style. The output is a natural-language prompt sentence string, such as:

“The temperature of a specific group of servers in the data center is 10 degrees Celsius higher than usual.

The operator has a high stress level and appears to be confused.

Explain three cooling countermeasures that can be executed step by step by a beginner.

Avoid technical jargon as much as possible.

For each step, clearly describe ‘what to do’ and ‘why it is necessary’.”

### Step 7:

The server transmits the prompt sentence to the generative AI model and obtains response information.

The input is the prompt sentence string generated in Step 6 and generation parameters such as maximum output length and randomness controls. The server constructs an API request containing the prompt sentence and sends it to a generative AI model endpoint. The underlying model processes the prompt sentence and generates a sequence of output tokens that form a natural-language response describing countermeasure procedures, settings, and cautions. The server receives the generated text from the endpoint as response information. The output is a response text string that the server stores temporarily for parsing.

### Step 8:

The server parses the response information into structured countermeasure candidate information.

The input is the response text produced by the generative AI model in Step 7. The server applies parsing rules to segment the text into discrete procedures and steps, recognizing patterns such as numbered lists, section headings, and key phrases. The server extracts, for each step, an action description and any explanation or rationale, and identifies specific configuration recommendations (for example, numeric thresholds or parameter values) and warning statements.

The server converts this parsed information into a structured representation, such as an object containing arrays of procedures, steps, parameters, and warnings. The output is structured countermeasure candidate information that the server saves in a database table associated with the triggering anomaly and user.

### Step 9:

The server sends the countermeasure candidate information and emotional state to the terminal for presentation.

The input is the structured countermeasure candidate information and the latest emotional state for the user session. The server constructs a response payload that includes the procedures, steps, parameters, warnings, and emotional label. The server serializes the payload and transmits it via a response message to the terminal's UI API. The server may also include references to relevant time-series metric data for visualization. The output is a response message containing all data needed for the terminal to render an adaptive operation support interface.

### Step 10:

The terminal renders an adaptive user interface for the countermeasure candidate information based on the emotional state.

The input is the response payload from the server containing the structured countermeasure candidate information and the emotional label. The terminal interprets the emotional label to select a display mode, such as guided mode for high stress or expert mode for calm and experienced. In guided mode, the terminal divides procedures into individual steps, shows one or a small number of steps per screen, uses simplified text, emphasizes warnings with visual cues, and generates confirmation dialogs before risky operations. In expert mode, the terminal displays all procedures and steps in a compact list, alongside charts of relevant metrics, and enables quick navigation among sections. The terminal processes the input data to construct view models for UI components and renders the corresponding screens on the display. The output is an interactive GUI that is visible and operable by the user.

### Step 11:

The user reviews the displayed countermeasure candidate information and selects operational actions.

The input is the adaptive GUI presented on the terminal, which displays step descriptions, parameter suggestions, and warnings. The user reads the explanations, evaluates the options, and interacts with the GUI by clicking buttons, selecting checkboxes, and entering or adjusting numeric parameters such as thresholds or schedule times. The user decides which steps or procedures to execute and confirms the choices by activating execution controls such as “Apply” or “Run” buttons. The output is a set of user interaction events and input values that represent the user's intended operational control instructions.

### Step 12:

The terminal converts user interactions into operation control instructions and sends them to the server.

The input is the set of user interaction events and parameter values captured in Step 11. The terminal analyzes the current UI state and maps each confirmed selection to an action type, target device identifiers, and associated parameters. The terminal assembles these into a structured operation control instruction object. The terminal then serializes this object and transmits it to the server via a control API over the network. The output is a control command message that instructs the server to perform specific operational changes on the information communication facility.

### Step 13:

The server validates and executes operation control instructions on the information communication facility.

The input is the control command message containing action types, target identifiers, and parameters received from the terminal. The server verifies security credentials and checks that each parameter complies with predefined safety and policy constraints stored in configuration tables. The server maps each action type to corresponding management interface calls, such as changing load-balancing rules, adjusting resource limits, or modifying cooling system setpoints. The server sends low-level commands or API requests to relevant infrastructure controllers and monitors their responses. The server aggregates execution statuses, error codes, and any returned data into a result object. The output is an execution result payload that the server logs for audit purposes and forwards to the terminal to update the user on the success or failure of the requested operations.

The data generation model 58 is a so-called generative artificial intelligence (AI).

Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

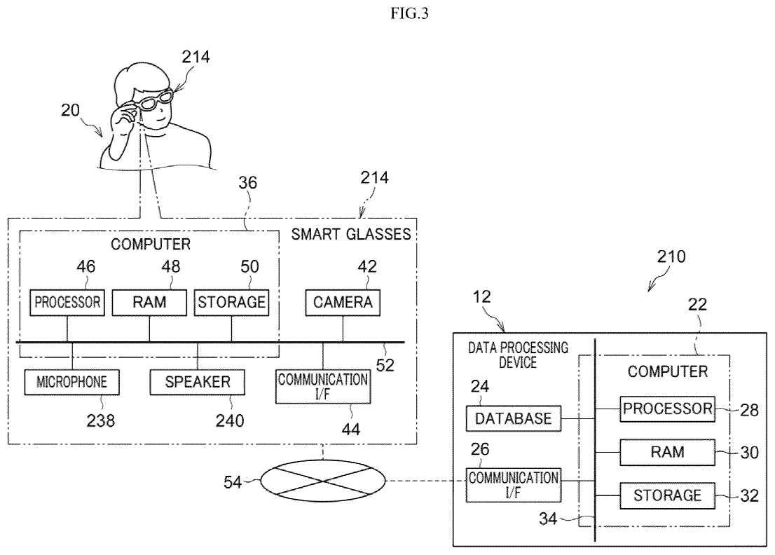

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

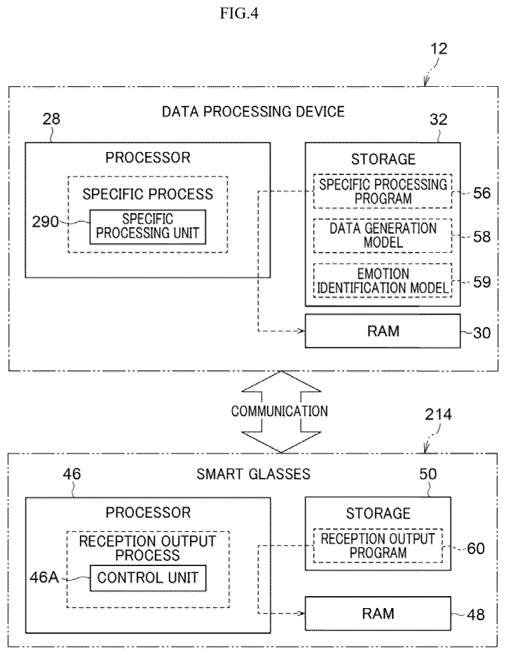

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI).

Examples of the data generation model 58 include generative AIs such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

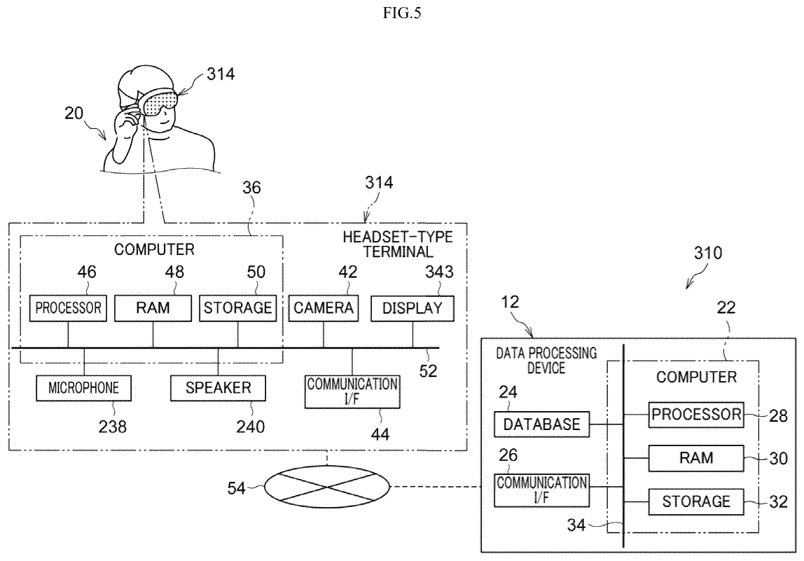

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

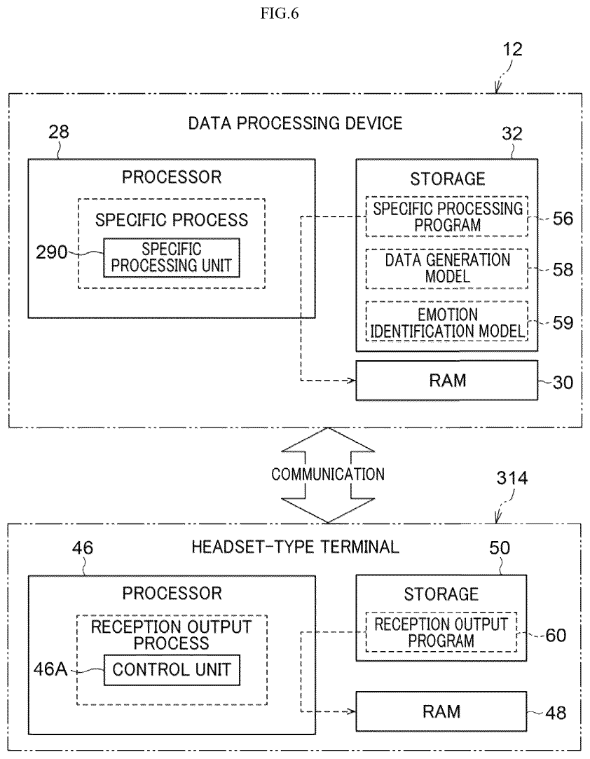

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

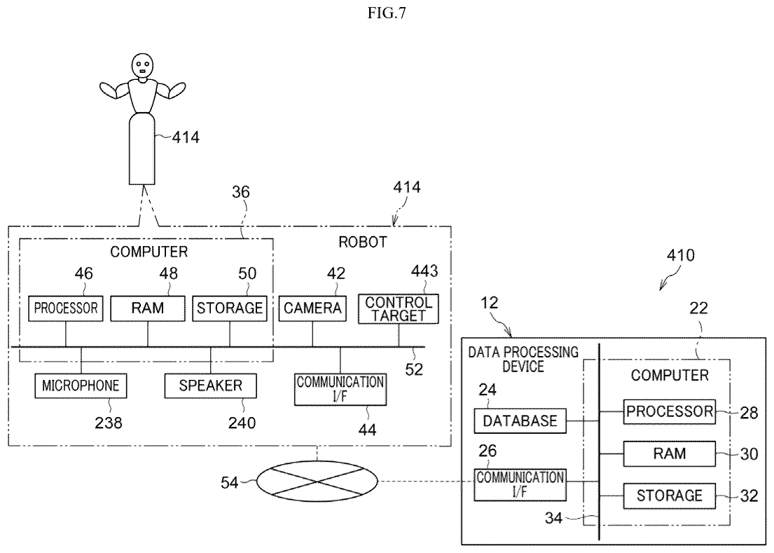

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

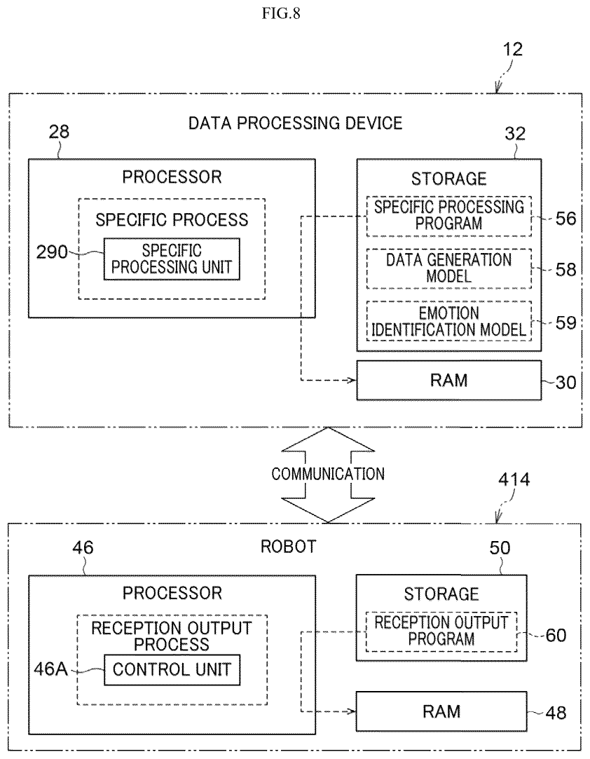

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above. The specific processing unit 290 transmits a result of the specific processing to the robot

414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

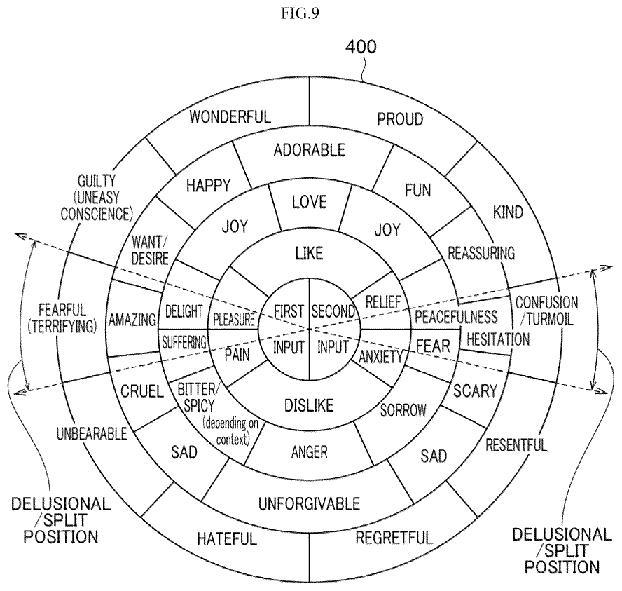

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center.

Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

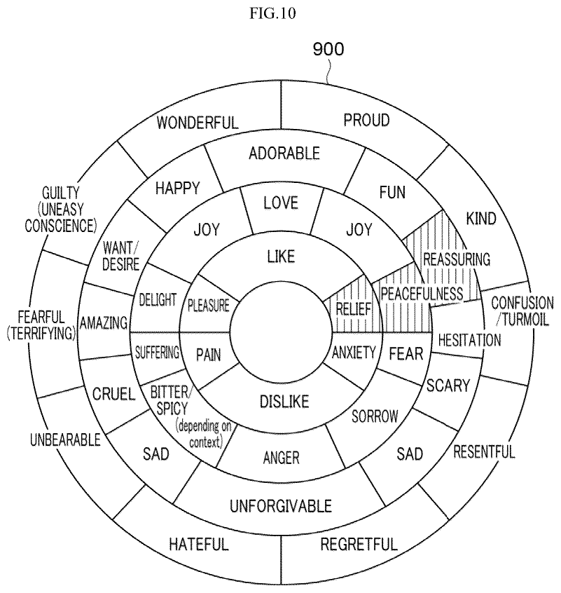

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from an information processing terminal operated by a user, input information including operating state information of an information processing environment, the input information including at least computation resource utilization information, storage resource utilization information, communication resource utilization information, and log information, and to control a display and an operation interface of the information processing terminal so that the user can input annotations regarding abnormal conditions,
store the input information as time-series data in a storage unit, perform aggregation processing and statistical value calculation processing on the time-series data to generate baseline information representing normal operation patterns and threshold information for anomaly determination, and store the baseline information and the threshold information in the storage unit,
receive, from the information processing terminal at a time of failure, failure information including at least failure occurrence time information, impact range information, display information, user report information, and log information, and store the failure information as failure event information in the storage unit,
execute, on character information included in the failure event information, text analysis processing including morphological analysis, feature extraction processing, and similarity calculation processing, compare the failure event information with past failure event information stored in the storage unit, extract similar failure events based on a similarity value, retrieve response procedure information associated with the similar failure events, and synthesize the response procedure information to generate response procedure information for a current failure event,
calculate an anomaly degree on the basis of the baseline information and the threshold information and on new state information received from the information processing terminal, determine that a potential future failure is present when the anomaly degree exceeds a criterion based on the threshold information, and generate prediction information and warning information indicating the potential future failure,
generate an input sentence describing a current technical situation, including at least computation resource utilization, communication resource utilization, and failure occurrence status, on the basis of the response procedure information and/or the prediction information and the warning information, construct a prompt sentence including the input sentence, transmit the prompt sentence to a generative information processing model, receive advice information expressed in natural language from the generative information processing model, and use the advice information as at least a part of the response procedure information and/or the warning information,
transmit the response procedure information and the advice information to the information processing terminal and control the information processing terminal to display the response procedure information and the advice information as procedures divided into steps,
and collect, from the information processing terminal, execution result information and evaluation information regarding execution of the response procedure information and the advice information, update parameters used in the similarity calculation processing and in the anomaly degree calculation processing on the basis of the execution result information and the evaluation information, and update construction rules of the prompt sentence used for the generative information processing model on the basis of the execution result information and the evaluation information.

### (Supplementary 2)

The system according to supplementary 1,
wherein the processor is configured to
generate, as the prompt sentence, a sentence including constraint conditions regarding at least a response format, a number of output steps, and prohibited matters, transmit the prompt sentence with the constraint conditions to the generative information processing model, receive the advice information expressed in natural language from the generative information processing model, and structure the advice information as step-numbered procedure information to be presented to the user through the information processing terminal.

### (Supplementary 3)

The system according to supplementary 1,
wherein the processor is configured to
update, on the basis of the execution result information and the evaluation information received from the information processing terminal, a template of the prompt sentence to be transmitted to the generative information processing model, and automatically adjust a selection criterion for the response procedure information extracted on the basis of the similarity calculation processing and the threshold information used in the anomaly degree calculation processing.

### Application Example 1

### (Supplementary 1)

A system comprising a processor,
wherein the processor is configured to
acquire, from an information processing apparatus group and a communication apparatus group, operating state information, resource utilization information, temperature information, electric power consumption information, and communication volume information, and record the acquired information as time-series data,
store the time-series data, learn a normal operation pattern based on the time-series data, and calculate an abnormality index,
acquire failure state information at a time of failure occurrence or anomaly detection and the abnormality index calculated by the processor, collate the failure state information and the abnormality index with past failure case information and known failure pattern information, and extract response candidate procedures,
generate a prompt sentence for input to a generative AI model based on the response candidate procedures, the latest time-series data acquired by the processor, and the abnormality index calculated by the processor,
input the generated prompt sentence to the generative AI model and receive, from the generative AI model, explanation information expressed in natural language and a plurality of response plan pieces of information,
integrate the received explanation information and the response plan pieces of information with the extracted response candidate procedures, edit the integrated information as response procedure information having an execution order, an importance level, and constraint conditions, and generate presentation data for an operator and automatic execution data,
notify the generated response procedure information to a terminal apparatus or a display apparatus, and acquire execution approval information or execution selection information from the terminal apparatus or the display apparatus,
instruct, based on the acquired execution approval information or execution selection information, at least one of load distribution control, cooling control, power saving control, and configuration change control to the information processing apparatus group and the communication apparatus group via a control interface, and store an execution result as history information, and
update the normal operation pattern and an abnormality determination criterion by using the history information and the explanation information, and reflect the updated normal operation pattern and the abnormality determination criterion in future failure prediction and response procedure generation.

### (Supplementary 2)

The system according to supplementary 1,
wherein the processor is configured to
extract, from the operating state information, the resource utilization information, the temperature information, the electric power consumption information, and the communication volume information acquired over a predetermined period, representative values, variation ranges, and threshold exceedance conditions, generate summary information of similar past failure cases based on the extracted values and conditions, and construct the prompt sentence so as to include the extracted values, the variation ranges, the threshold exceedance conditions, and the summary information, the prompt sentence requesting the generative AI model to present cause analysis, immediate countermeasures, and short-term improvement measures.

### (Supplementary 3)

The system according to supplementary 1,
wherein the processor is configured to
select, from among the response plan pieces of information received from the generative AI model, only response plans that conform to predetermined operation rule information and safety standard information, classify the selected response plans into an automatic execution procedure executable by the processor and a manual execution procedure to be performed by an operator, and generate the response procedure information including the automatic execution procedure and the manual execution procedure.

### Example 2

### (Supplementary 1)

A system comprising a processor,
wherein the processor is configured to
acquire operation state information and failure information via an input unit, store the acquired operation state information and the acquired failure information in a storage unit, and learn, based on the stored operation state information, a normal operation pattern and an abnormal state determination criterion for an information processing apparatus group,
acquire, from a terminal, at least one of an inquiry text of a user, an evaluation information item of the user, and an operation history of the user, apply an emotion analysis model including a natural language processing model and a behavior analysis model to the at least one of the inquiry text, the evaluation information item, and the operation history, calculate an emotion score representing at least anger, dissatisfaction, confusion, anxiety, satisfaction, and neutrality, and store the emotion score in association with user identification information and time information in the storage unit,
compare, at a time of occurrence of a failure, current failure information acquired via the input unit and a current emotion score calculated by the emotion analysis model with past failure information and past emotion scores stored in the storage unit, determine similarity of at least failure content and emotional state, and extract a similar failure case based on the determined similarity,
generate, based on situation information including the similar failure case, current operation state information, the current failure information, and the current emotion score, a prompt sentence in a natural language for a generative AI model, input the prompt sentence to the generative AI model, and acquire, from the generative AI model, a response text including a technical failure handling procedure and a user-oriented message according to an emotional state,
analyze the acquired response text, extract, from the response text, technical failure handling procedure information for an operator and user-oriented message information, and transmit the technical failure handling procedure information to an operator terminal and transmit the user-oriented message information to a user terminal so that the information is displayed or sent on the user terminal, and
detect, based on a temporal transition of the operation state information and a temporal transition of the emotion scores stored in the storage unit, a sign of emotional deterioration by using a prediction model configured to output a probability of occurrence of emotional deterioration at a future time, generate, based on a prediction result of the prediction model and current operation state information, a preventive prompt sentence for the generative AI model, input the preventive prompt sentence to the generative AI model, acquire a preventive technical countermeasure procedure and an advance guidance message from the generative AI model, and transmit, via a notification unit, a preventive guidance notification based on the preventive technical countermeasure procedure and the advance guidance message to at least one terminal.

### (Supplementary 2)

The system according to supplementary 1,
wherein the processor is configured to
periodically or intermittently acquire, via the input unit, the operation state information including at least operation status of the information processing apparatus group, processing resource usage, storage resource usage, communication amount, response time, error rate, and log information, calculate, based on the operation state information and the log information, at least one of a reference value and a variance value for each of a time segment or an operation condition, and supply the at least one of the reference value and the variance value, in combination with the emotion scores, as a feature to the prediction model so that a relationship between a change in operation state and emotional deterioration is learned.

### (Supplementary 3)

The system according to supplementary 1,
wherein the processor is configured to
generate the prompt sentence by embedding, into a predefined template, past case information including a failure handling procedure executed in the similar failure case and an outcome index of the failure handling procedure, the current operation state information, and the current emotion score by string processing, input the prompt sentence thus generated to the generative AI model, acquire the response text from the generative AI model, parse the response text based on at least one of a format and a delimiter to mechanically separate the technical failure handling procedure information for the operator and the user-oriented message information, and output the separated technical failure handling procedure information and the separated user-oriented message information as structured data to the notification unit.

### Application Example 2

### (Supplementary 1)

A system comprising a processor,
wherein the processor is configured to
acquire operational state data from a plurality of detection devices provided in an information communication facility, normalize the operational state data, store the normalized operational state data as time-series data in a storage device, learn a normal operational pattern by executing statistical processing or machine learning processing on the stored operational state data, and determine an abnormal state based on a deviation from the normal operational pattern,
acquire at least one of voice data, character data, and operation history data transmitted from an information processing terminal operated by a user, perform signal processing on the voice data to extract acoustic feature data, perform natural language processing on the character data to extract linguistic feature data, perform analysis on the operation history data to extract operation feature data including operation frequency, error operation count, and non-operation time, estimate an integrated emotional state of the user based on the acoustic feature data, the linguistic feature data, and the operation feature data, and store an estimation result as state information for each user in the storage device,
generate, in accordance with the abnormal state determined based on the operational state data and the emotional state estimated based on the user-related data, a prompt sentence that includes content of the abnormal state, a state of a target device, and the emotional state of the user, the prompt sentence being written in natural language and including conditions or instructions for causing a generative AI model to generate response content,
input the generated prompt sentence into the generative AI model, obtain response information written in natural language from the generative AI model, analyze the response information to extract information including countermeasure procedures for the abnormal state, configuration change contents, and cautions, generate countermeasure candidate information as structured data based on the extracted information, and store the countermeasure candidate information in the storage device,
control, based on the countermeasure candidate information and the emotional state, a display format, an information amount, and a procedure segmentation method on a display screen, such that, when the emotional state indicates a high-stress state or a confused state, the processor causes the countermeasure procedures to be displayed stepwise with a reduced information amount per screen and causes a confirmation operation to be requested before execution, and such that, when the emotional state indicates a calm state and an experienced state, the processor causes the countermeasure procedures to be displayed in an aggregated list format, thereby presenting the countermeasure candidate information to the user via the information processing terminal, and
acquire an operation control instruction input by the user via the information processing terminal, execute, based on the operation control instruction, control processing including at least one of operational setting control, resource allocation control, load balancing control, and cooling control for the information communication facility through a management interface, and transmit an execution result to the information processing terminal.

(Supplementary 2)

The system according to supplementary 1,
wherein the processor is configured to
control generation of the prompt sentence such that, when the emotional state is determined to indicate a high-stress state or a confused state, the prompt sentence includes instructions to suppress use of technical terms, to describe for each operation step what action should be performed and why the action is necessary, and to cause a plurality of countermeasure procedures to be generated in a step-by-step executable format, and such that, when the emotional state is determined to indicate a calm state and an experienced state, the prompt sentence includes instructions to permit use of technical terms, to present key points in concise bullet-point form, and to add, for each countermeasure, a short description of an expected effect and a risk.

### (Supplementary 3)

The system according to supplementary 1,
wherein the processor is configured to
control presentation of the countermeasure candidate information such that, when the emotional state is determined to indicate a high-stress state or a confused state, each countermeasure procedure included in the countermeasure candidate information is divided into one or a small number of steps per screen and displayed, and a confirmation screen is displayed before execution of an operation having a high degree of risk in order to request operation confirmation from the user, and such that, when the emotional state is determined to indicate a calm state and an experienced state, the entirety of the countermeasure candidate information is displayed on a single screen in a list format, and time-series operational state data related to the abnormal state is presented together, thereby enabling the user to perform judgment and operation efficiently.

What is claimed is:

1. A system comprising:
circuitry configured to:
receive, via a communication interface coupled to a packet-switched network, system state data from one or more monitored computing devices at periodic intervals;
store the system state data in a storage device and learn normal operating patterns based on the stored system state data;
receive failure event data from the one or more monitored computing devices, compare the failure event data against stored failure records, and generate response procedure data based on a result of the comparison; and
analyze the system state data to detect anomalous trends, predict potential failures, and transmit notification data to a terminal device via the communication interface.

2. The system according to claim 1, wherein the system state data includes at least operating status data, resource utilization data, and event log data, and wherein the circuitry normalizes the system state data and stores the normalized data as time-series records indexed by device identifier and timestamp.

3. The system according to claim 2, wherein the circuitry trains a machine learning model comprising a neural network on the time-series records to establish baseline patterns for each monitored computing device, and detects deviations from the baseline patterns by computing anomaly scores for each incoming system state data point.

4. The system according to claim 3, wherein the circuitry classifies detected anomalies into severity categories based on the anomaly scores and generates prioritized alert data for anomalies exceeding a critical severity threshold.

5. The system according to claim 4, wherein the circuitry correlates anomalies detected across a plurality of monitored computing devices based on temporal proximity and causal dependency relationships stored in a topology data structure, and identifies root cause candidates from the correlated anomalies.

6. The system according to claim 1, wherein the failure event data includes at least a failure occurrence timestamp, an affected component identifier, an error message, and symptom description data, and wherein the circuitry generates embedding vectors from the failure event data using a neural network encoder.

7. The system according to claim 6, wherein the circuitry executes a similarity search against embedding vectors of the stored failure records to identify matching past failure events, and retrieves the response procedure data associated with the highest-similarity matching failure records.

8. The system according to claim 7, wherein the circuitry constructs a prompt data structure encoding the failure event data, the matching failure records, and the associated response procedure data, transmits the prompt data structure to a generative neural network model comprising a transformer-based architecture, and receives refined response procedure data adapted to the specific failure context.

9. The system according to claim 1, wherein the circuitry analyzes the system state data using a time-series prediction model comprising a recurrent neural network to forecast future system state values, and predicts potential failures when forecast values exceed degradation thresholds for a sustained period.

10. The system according to claim 9, wherein the circuitry generates preventive action recommendation data by constructing a prompt data structure encoding the forecast data and the degradation thresholds, transmitting the prompt data structure to a generative neural network model, and receiving preventive action text.

11. The system according to claim 10, wherein the notification data includes the preventive action recommendation data, a predicted failure timeline, an affected component identifier, and a confidence score, and wherein the circuitry prioritizes notifications based on the predicted failure timeline.

12. The system according to claim 1, wherein the circuitry is further configured to receive feedback data from the terminal device indicating whether the response procedure data successfully resolved the failure event, and to update the stored failure records based on the feedback data.

13. The system according to claim 12, wherein the circuitry stores each failure event, the applied response procedure, and the resolution outcome as a new failure record in the storage device, and updates similarity scoring weights based on accumulated resolution outcomes.

14. The system according to claim 1, wherein the circuitry generates periodic health report data summarizing system state trends, detected anomalies, predicted risks, and resolution statistics across the one or more monitored computing devices, and transmits the health report data to the terminal device.

15. The system according to claim 14, wherein the circuitry constructs a report prompt data structure encoding the health report data and transmits the report prompt data structure to a generative neural network model to obtain a natural language summary with prioritized recommendations.

16. The system according to claim 1, wherein the circuitry estimates an operator workload level based on a volume and severity of active notifications and pending failure events, and adjusts a granularity of the notification data based on the estimated workload level.

17. The system according to claim 16, wherein the circuitry aggregates related notifications into consolidated notification groups when the estimated workload level exceeds a threshold, and expands the consolidated groups into individual notifications when the workload level decreases below the threshold.

18. A system comprising:
circuitry configured to:
receive, via a communication interface coupled to a packet-switched network, system state data from one or more monitored computing devices at periodic intervals and store the system state data as time-series records in a storage device;
train a machine learning model comprising a neural network on the time-series records to establish baseline patterns and detect anomalies by computing anomaly scores for incoming system state data;
receive failure event data from the monitored computing devices, generate embedding vectors from the failure event data using a neural network encoder, execute a similarity search against stored failure records, and generate response procedure data;
construct prompt data structures and transmit to a generative neural network model comprising a transformer architecture to obtain refined response procedures and preventive action recommendations;
predict potential failures using a time-series prediction model comprising a recurrent neural network to forecast future system state values; and
transmit notification data including prioritized alerts and preventive recommendations to a terminal device via the communication interface.

19. The system according to claim 18, wherein the circuitry is further configured to estimate an operator workload level and to adjust granularity of the notification data based on the estimated workload level.

20. A method performed by circuitry of a server coupled to a packet-switched network via a communication interface, the method comprising:
receiving, via the communication interface, system state data from one or more monitored computing devices at periodic intervals;
storing the system state data in a storage device and learning normal operating patterns based on the stored system state data;
receiving failure event data from the one or more monitored computing devices, comparing the failure event data against stored failure records, and generating response procedure data based on a result of the comparison; and
analyzing the system state data to detect anomalous trends, predicting potential failures, and transmitting notification data to a terminal device via the communication interface.
